(19) United States
(12) Patent Application Publication
(10) Pub. No.: US 2026/0361377 A1
(43) Pub. Date: Nov. 12, 2026

(54) REFERENCE SIGNAL QUALITY INDICATION FOR UPLINK BEAM PREDICTION

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/469,931

(22) PCT Filed: May 16, 2023
(86) PCT No.: PCT/CN2023/094454

§ 371 Date: Sep. 26, 2025

(51) Int. Cl. H04B 7/06; H04L 5/00; H04W 24/10

(52) U.S. Cl. CPC H04B 7/06952; H04L 5/0048; H04W 24/10

(57) ABSTRACT

Methods, systems, and devices for wireless communications are described. A user equipment (UE) may transmit a set of sounding reference signals (SRSs) via a set of reference signal resource sets to a network entity using a set of beams of the UE. The UE may receive a control signal from the network entity indicating one or more reference signal measurements corresponding to one or more reference signal resource sets of the set of reference signal resource sets based on the set of SRSs. The UE may they perform a beam prediction procedure to obtain an uplink beam of the UE for transmitting an uplink message to the network entity based on the one or more reference signal measurements corresponding to the one or more reference signal resource sets. The UE may then transmit the uplink message using the uplink beam based on the beam prediction procedure.

### CROSS REFERENCE

The present Application for Patent is a 371 national phase filing of International Patent Application No. PCT/CN2023/094454 by LI et al., entitled “REFERENCE SIGNAL QUALITY INDICATION FOR UPLINK BEAM PREDICTION,” filed May 16, 2023, assigned to the assignee hereof, and expressly incorporated by reference herein.

### FIELD OF TECHNOLOGY

The following relates to wireless communications, including reference signal quality indication for uplink beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support reference signal quality indication for uplink beam prediction. For example, the described techniques provide for a user equipment (UE) transmitting a set of sounding reference signals (SRSs) via a set of reference signal resource sets to a network entity using a set of beams of the UE. The UE may receive a control signal from the network entity indicating one or more reference signal measurements corresponding to one or more reference signal resource sets of the set of reference signal resource sets based on the set of SRSs. The UE may they perform a beam prediction procedure to obtain an uplink beam of the UE for transmitting an uplink message to the network entity based on the one or more reference signal measurements corresponding to the one or more reference signal resource sets. The UE may then transmit the uplink message using the uplink beam based on the beam prediction procedure.

A method for wireless communication at a UE is described. The method may include transmitting, to a network entity and using a set of multiple beams of the UE, a set of multiple SRSs via a set of multiple reference signal resource sets, receiving, from the network entity, a control signal indicating one or more reference signal measurements corresponding to one or more reference signal resource sets of the set of multiple reference signal resource sets based on the set of multiple SRSs, performing, based on the one or more reference signal measurements corresponding to the one or more reference signal resource sets, a beam prediction procedure to obtain an uplink beam of the UE for transmission of an uplink message to the network entity, and transmitting, to the network entity, the uplink message using the uplink beam of the UE based on the beam prediction procedure.

An apparatus for wireless communication at a UE is described. The apparatus may include a processor, memory coupled with the processor, and instructions stored in the memory. The instructions may be executable by the processor to cause the apparatus to transmit, to a network entity and using a set of multiple beams of the UE, a set of multiple SRSs via a set of multiple reference signal resource sets, receive, from the network entity, a control signal indicating one or more reference signal measurements corresponding to one or more reference signal resource sets of the set of multiple reference signal resource sets based on the set of multiple SRSs, perform, based on the one or more reference signal measurements corresponding to the one or more reference signal resource sets, a beam prediction procedure to obtain an uplink beam of the UE for transmission of an uplink message to the network entity, and transmit, to the network entity, the uplink message using the uplink beam of the UE based on the beam prediction procedure.

Another apparatus for wireless communication at a UE is described. The apparatus may include means for transmitting, to a network entity and using a set of multiple beams of the UE, a set of multiple SRSs via a set of multiple reference signal resource sets, means for receiving, from the network entity, a control signal indicating one or more reference signal measurements corresponding to one or more reference signal resource sets of the set of multiple reference signal resource sets based on the set of multiple SRSs, means for performing, based on the one or more reference signal measurements corresponding to the one or more reference signal resource sets, a beam prediction procedure to obtain an uplink beam of the UE for transmission of an uplink message to the network entity, and means for transmitting, to the network entity, the uplink message using the uplink beam of the UE based on the beam prediction procedure.

A non-transitory computer-readable medium storing code for wireless communication at a UE is described. The code may include instructions executable by a processor to transmit, to a network entity and using a set of multiple beams of the UE, a set of multiple SRSs via a set of multiple reference signal resource sets, receive, from the network entity, a control signal indicating one or more reference signal measurements corresponding to one or more reference signal resource sets of the set of multiple reference signal resource sets based on the set of multiple SRSs, perform, based on the one or more reference signal measurements corresponding to the one or more reference signal resource sets, a beam prediction procedure to obtain an uplink beam of the UE for transmission of an uplink message to the network entity, and transmit, to the network entity, the uplink message using the uplink beam of the UE based on the beam prediction procedure.

In some examples of the method, apparatuses, and non-transitory computer-readable medium described herein, receiving the control signal may include operations, features, means, or instructions for receiving the control signal including respective reference signal resource identifiers (IDs) corresponding to the one or more reference signal measurements, the respective reference signal resource IDs associated with at least one reference signal resource set of the set of multiple reference signal resource sets.

In some examples of the method, apparatuses, and non-transitory computer-readable medium described herein, receiving the control signal may include operations, features, means, or instructions for receiving the control signal indicating a reference signal measurement of a SRS associated with a reference signal transmission occasion, the reference signal transmission occasion being a last reference signal transmission occasion before a set of time resources allocated for the control signal, where the one or more reference signal measurements includes the reference signal measurement.

In some examples of the method, apparatuses, and non-transitory computer-readable medium described herein, receiving the control signal may include operations, features, means, or instructions for receiving the control signal indicating a reference signal measurement of a SRS according to a time domain offset, the time domain offset indicating a time duration between the transmission of the set of multiple SRSs and a set of time resources allocated for the control signal, where the one or more reference signal measurements includes the reference signal measurement, and where the set of multiple SRSs includes the SRS.

In some examples of the method, apparatuses, and non-transitory computer-readable medium described herein, receiving the control signal may include operations, features, means, or instructions for receiving the control signal indicating that the one or more reference signal measurements corresponds to two or more reference signal resource sets of the set of multiple reference signal resource sets, the two or more reference signal resource sets being within a time window associated with a filtering scheme associated with the one or more reference signal measurements.

Some examples of the method, apparatuses, and non-transitory computer-readable medium described herein may further include operations, features, means, or instructions for receiving, from the network entity, a second control signal indicating that measurements for at least one of the one or more reference signal resource sets may be to be included in the control signal.

Some examples of the method, apparatuses, and non-transitory computer-readable medium described herein may further include operations, features, means, or instructions for transmitting, to the network entity, a request for the network entity to include measurements for at least one of the one or more reference signal resource sets in the control signal.

In some examples of the method, apparatuses, and non-transitory computer-readable medium described herein, receiving the control signal may include operations, features, means, or instructions for receiving, in the control signal, a first set of bits indicating a first measurement of a first reference signal resource set of the set of multiple reference signal resource sets, and a second set of bits indicating a differential measurement relative to the first measurement, where the differential measurement relative to the first measurement indicates a quantized differential between the first measurement and a second measurement, and where a quantity of the first set of bits may be greater than a quantity of the second set of bits.

In some examples of the method, apparatuses, and non-transitory computer-readable medium described herein, receiving the control signal may include operations, features, means, or instructions for receiving, from the network entity, a SRS resource indicator (SRI) indicating the one or more reference signal resource sets according to an order that may be based on the one or more reference signal measurements.

Some examples of the method, apparatuses, and non-transitory computer-readable medium described herein may further include operations, features, means, or instructions for communicating an indication of a measurement threshold with the network entity, where the one or more reference signal measurements satisfy the measurement threshold.

In some examples of the method, apparatuses, and non-transitory computer-readable medium described herein, the one or more reference signal measurements correspond to a first reference signal resource set associated with a first periodicity and the uplink beam may be obtained for the transmission of the uplink message via a second reference signal resource set different from the first reference signal resource set, where the uplink message includes a SRS different from the set of multiple SRSs.

In some examples of the method, apparatuses, and non-transitory computer-readable medium described herein, performing the beam prediction procedure may include operations, features, means, or instructions for receiving, from the network entity, the control signal indicating the one or more reference signal measurements corresponding to a first reference signal resource set of the set of multiple reference signal resource sets and performing, based on the one or more reference signal measurements corresponding to the first reference signal resource set, the beam prediction procedure to predict the uplink beam of the UE for subsequent communications using the first reference signal resource set.

In some examples of the method, apparatuses, and non-transitory computer-readable medium described herein, the set of multiple SRSs may be transmitted according to a first transmission configuration indicator (TCI) state and the method, apparatuses, and non-transitory computer-readable medium may include further operations, features, means, or instructions for receiving, from the network entity, a second control signal indicating a switch from the first TCI state to a second transmission indicator state for the uplink message, where the uplink message may be transmitted based on the second transmission indicator state.

In some examples of the method, apparatuses, and non-transitory computer-readable medium described herein, receiving the control signal may include operations, features, means, or instructions for receiving a medium access control control element message (MAC-CE), a radio resource control (RRC) message, an uplink grant downlink control information (DCI) message, or a downlink grant that indicates the one or more reference signal measurements.

A method for wireless communication at a network entity is described. The method may include receiving, from a UE via a set of multiple beams of the UE, a set of multiple SRSs via a set of multiple reference signal resource sets, transmitting, to the UE, a control signal indicating one or more reference signal measurements corresponding to one or more reference signal resource sets of the set of multiple reference signal resource sets based on the set of multiple SRSs, and receiving, from the UE, an uplink message using an uplink beam of the UE.

An apparatus for wireless communication at a network entity is described. The apparatus may include a processor, memory coupled with the processor, and instructions stored in the memory. The instructions may be executable by the processor to cause the apparatus to receive, from a UE via a set of multiple beams of the UE, a set of multiple SRSs via a set of multiple reference signal resource sets, transmit, to the UE, a control signal indicating one or more reference signal measurements corresponding to one or more reference signal resource sets of the set of multiple reference signal resource sets based on the set of multiple SRSs, and receive, from the UE, an uplink message using an uplink beam of the UE.

Another apparatus for wireless communication at a network entity is described. The apparatus may include means for receiving, from a UE via a set of multiple beams of the UE, a set of multiple SRSs via a set of multiple reference signal resource sets, means for transmitting, to the UE, a control signal indicating one or more reference signal measurements corresponding to one or more reference signal resource sets of the set of multiple reference signal resource sets based on the set of multiple SRSs, and means for receiving, from the UE, an uplink message using an uplink beam of the UE.

A non-transitory computer-readable medium storing code for wireless communication at a network entity is described. The code may include instructions executable by a processor to receive, from a UE via a set of multiple beams of the UE, a set of multiple SRSs via a set of multiple reference signal resource sets, transmit, to the UE, a control signal indicating one or more reference signal measurements corresponding to one or more reference signal resource sets of the set of multiple reference signal resource sets based on the set of multiple SRSs, and receive, from the UE, an uplink message using an uplink beam of the UE.

In some examples of the method, apparatuses, and non-transitory computer-readable medium described herein, transmitting the control signal may include operations, features, means, or instructions for transmitting the control signal including respective reference signal resource IDs corresponding to the one or more reference signal measurements, the respective reference signal resource IDs associated with at least one reference signal resource set of the set of multiple reference signal resource sets.

In some examples of the method, apparatuses, and non-transitory computer-readable medium described herein, transmitting the control signal may include operations, features, means, or instructions for transmitting the control signal indicating a reference signal measurement of a SRS associated with a reference signal transmission occasion, the reference signal transmission occasion being a last reference signal transmission occasion before a set of time resources allocated for the control signal, where the one or more reference signal measurements includes the reference signal measurement.

In some examples of the method, apparatuses, and non-transitory computer-readable medium described herein, transmitting the control signal may include operations, features, means, or instructions for transmitting the control signal indicating a reference signal measurement of a SRS according to a time domain offset, the time domain offset indicating a time duration between transmission of the set of multiple SRSs and a set of time resources allocated for the control signal, where the one or more reference signal measurements includes the reference signal measurement, and where the set of multiple SRSs includes the SRS.

In some examples of the method, apparatuses, and non-transitory computer-readable medium described herein, transmitting the control signal may include operations, features, means, or instructions for transmitting the control signal indicating that the one or more reference signal measurements corresponds to two or more reference signal resource sets of the set of multiple reference signal resource sets, the two or more reference signal resource sets being within a time window associated with a filtering scheme associated with the one or more reference signal measurements.

Some examples of the method, apparatuses, and non-transitory computer-readable medium described herein may further include operations, features, means, or instructions for transmitting, to the UE, a second control signal indicating that measurements for at least one of the one or more reference signal resource sets may be to be included in the control signal.

Some examples of the method, apparatuses, and non-transitory computer-readable medium described herein may further include operations, features, means, or instructions for receiving, from the UE, a request for the network entity to include measurements for at least one of the one or more reference signal resource sets in the control signal.

In some examples of the method, apparatuses, and non-transitory computer-readable medium described herein, transmitting the control signal may include operations, features, means, or instructions for transmitting, in the control signal, a first set of bits indicating a first measurement of a first reference signal resource set of the set of multiple reference signal resource sets, and a second set of bits indicating a differential measurement relative to the first measurement, where the differential measurement relative to the first measurement indicates a quantized differential between the first measurement and a second measurement, and where a quantity of the first set of bits may be greater than a quantity of the second set of bits.

In some examples of the method, apparatuses, and non-transitory computer-readable medium described herein, transmitting the control signal may include operations, features, means, or instructions for transmitting, to the UE, an SRI indicating the one or more reference signal resource sets according to an order that may be based on the one or more reference signal measurements.

Some examples of the method, apparatuses, and non-transitory computer-readable medium described herein may further include operations, features, means, or instructions for communicating an indication of a measurement threshold with the UE, where the one or more reference signal measurements satisfy the measurement threshold.

In some examples of the method, apparatuses, and non-transitory computer-readable medium described herein, the one or more reference signal measurements correspond to a first reference signal resource set associated with a first periodicity.

In some examples of the method, apparatuses, and non-transitory computer-readable medium described herein, the set of multiple SRSs may be received according to a first TCI state and the method, apparatuses, and non-transitory computer-readable medium may include further operations, features, means, or instructions for transmitting, to the UE, a second control signal indicating a switch from the first TCI state to a second transmission indicator state for the uplink message, where the uplink message may be transmitted based on the second transmission indicator state.

In some examples of the method, apparatuses, and non-transitory computer-readable medium described herein, transmitting the control signal may include operations, features, means, or instructions for transmitting a MAC-CE message, an RRC, an uplink grant DCI message, or a downlink grant that indicates the one or more reference signal measurements.

### BRIEF DESCRIPTION OF THE DRAWINGS

FIG. 1 shows an example of a wireless communications system that supports reference signal quality indication for uplink beam prediction in accordance with one or more aspects of the present disclosure.

FIG. 2 shows an example of a wireless communications system that supports reference signal quality indication for uplink beam prediction in accordance with one or more aspects of the present disclosure.

FIG. 3A though 4 show examples of beam measurement timing diagrams that support reference signal quality indication for uplink beam prediction in accordance with one or more aspects of the present disclosure.

FIG. 5A through 7 show examples of resource set selection diagrams that support reference signal quality indication for uplink beam prediction in accordance with one or more aspects of the present disclosure.

FIG. 8 shows an example of a machine learning diagram that supports reference signal quality indication for uplink beam prediction in accordance with one or more aspects of the present disclosure.

FIG. 9 shows an example of a process flow that supports reference signal quality indication for uplink beam prediction in accordance with one or more aspects of the present disclosure.

FIGS. 10 and 11 show block diagrams of devices that support reference signal quality indication for uplink beam prediction in accordance with one or more aspects of the present disclosure.

FIG. 12 shows a block diagram of a communications manager that supports reference signal quality indication for uplink beam prediction in accordance with one or more aspects of the present disclosure.

FIG. 13 shows a diagram of a system including a device that supports reference signal quality indication for uplink beam prediction in accordance with one or more aspects of the present disclosure.

FIGS. 14 and 15 show block diagrams of devices that support reference signal quality indication for uplink beam prediction in accordance with one or more aspects of the present disclosure.

FIG. 16 shows a block diagram of a communications manager that supports reference signal quality indication for uplink beam prediction in accordance with one or more aspects of the present disclosure.

FIG. 17 shows a diagram of a system including a device that supports reference signal quality indication for uplink beam prediction in accordance with one or more aspects of the present disclosure.

FIGS. 18 through 22 show flowcharts illustrating methods that support reference signal quality indication for uplink beam prediction in accordance with one or more aspects of the present disclosure.

### DETAILED DESCRIPTION

In some wireless communication systems, user equipments (UEs) may communicate with a network entity using transmit beams. To determine which transmit beam(s) to use for communications with the network entity, the UE may perform a beam sweeping procedure. During the beam sweeping procedure, the UE may transmit reference signals (e.g., sounding reference signals (SRSs)) using each of the different transmit beams supported by the UE, and by measuring these reference signals, the network entity may select a transmit beam for the UE. However, traditional beam sweeping techniques are time-consuming and resource heavy. Also, as the number of transmit beams supported by a UE, sweeping through all the beams adds to the complexity and increases latency of the beam sweeping procedure. As such, having the UE perform beam sweeping procedures in this manner may be inefficient or in some cases, unsuitable, as technology and UE capabilities improve over time.

Therefore a UE capable of receiving reference signal measurements from the network entity may receive such measurements and use the measurements to predict beams for communicating with the network entity. To obtain the reference signal measurements, the UE may transmit SRSs to a network entity and the network entity may perform measurements on the reference signals from the UE. The network entity may transmit the reference signal measurements to the UE to aid in performing beam predictions rather than the UE performing beam sweeping across all supported beams to determine an uplink transmission beam. In some cases, the network entity may transmit the reference signal measurements after an SRS transmission, after a time offset, or within a time window. The network entity may also indicate a reference signal measurement corresponding to a specific SRS resource set that may be preconfigured or selected by the UE or the network entity. Such reference signal measurement indications may allow the UE to more accurately predict future uplink transmission beams while refraining from having to perform beam sweeping across all beams or randomly choosing beams, which may decrease latency, time, and resource consumption at the UE.

Aspects of the disclosure are initially described in the context of wireless communications systems. Additional aspects of the disclosure are described herein with reference to a wireless communications system, beam measurement timing diagrams, resource set selection diagrams, a machine learning diagram, and a process flow.

Aspects of the disclosure are further illustrated by and described with reference to apparatus diagrams, system diagrams, and flowcharts that relate to reference signal quality indication for uplink beam prediction.

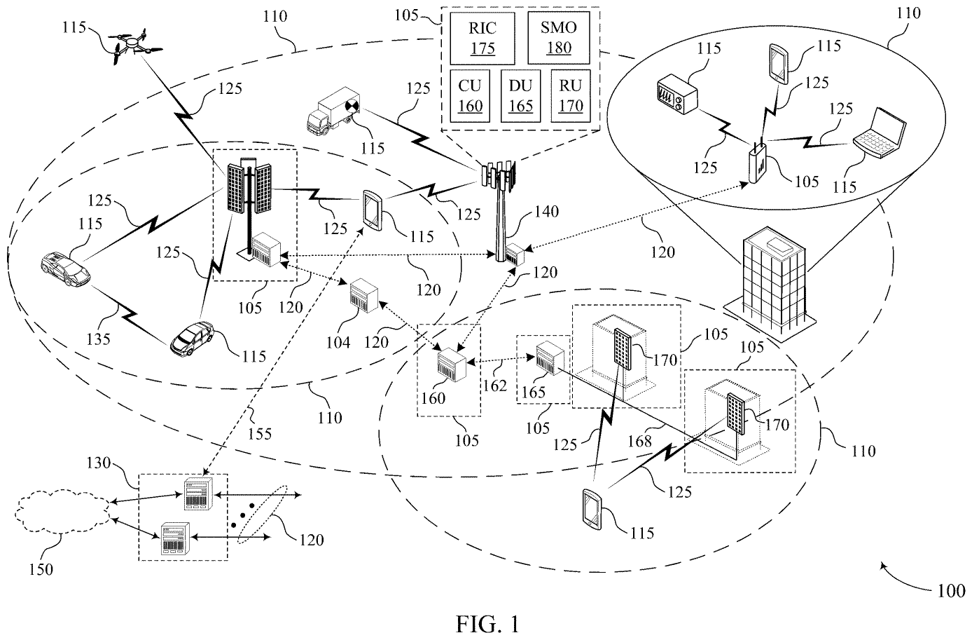

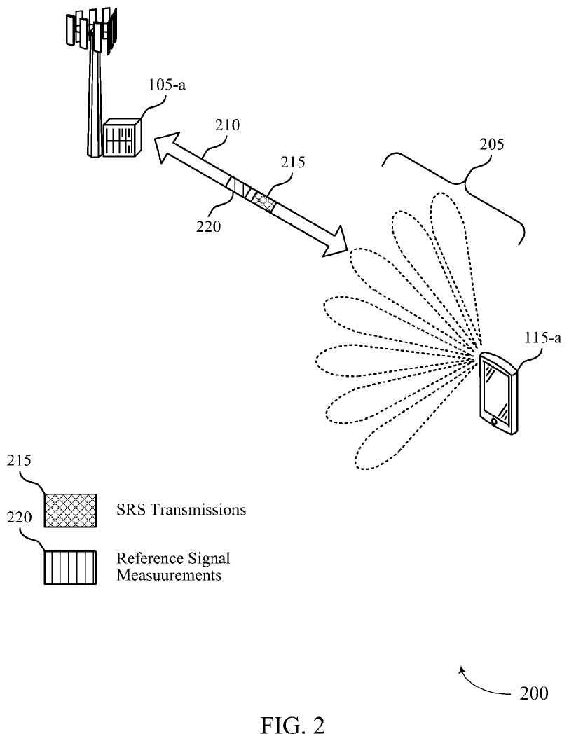

FIG. 1 shows an example of a wireless communications system 100 that supports reference signal quality indication for uplink beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support reference signal quality indication for uplink beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the EHF band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, the UE 115 and the network entity 105 may use artificial intelligence (AI) or machine learning procedures and models to enhance beam management. For example, such AI and machine learning models may be used for beam predictions in the time domain, beam predictions in the spatial domain, or both, to reduce overhead and latency and increase beam selection accuracies. In some cases, the AI and machine learning techniques may support collaborations between the network entity 105 and the UE 115. As such, the network entity 105 and the UE 115 may perform model training, model deployment, model inference, model monitoring, and model updating for the various AI and machine learning models used for beam prediction to identify common characteristics or specific characteristics for the beam predictions.

In some examples, wireless devices that support AI and machine learning based beam management (e.g., the UE 115 and the network entity 105) may support a first beam management case and a second beam management case for characterization and baseline performance evaluations. The first beam management case may include the wireless devices performing spatial-domain downlink beam predictions for a first set of beams based on measurement results of a second set of beams. In some cases, the second set of beams may be a subset of the first set of beams, where the wireless device may select or generate the second set of beams via a fixed pattern, a random pattern, or any other type of technique. In some cases, the first set of beams and the second set of beams may be different (e.g., the first set of beams include narrow beams and the second set of beams include wide beams). In some examples, the first set of beams and the second set of beams may have a same quantity of beams, have different quantities of beams, be quasi co-located (QCL) with each other, or any combination thereof.

The second beam management case may include the wireless devices performing temporal downlink beam predictions for the first set of beams based on historic measurement results of the second set of beams. That is, the AI and machine learning models may be used to discover patterns in the historical measurement results of the second set of beams to generate the temporal downlink beam predictions for the first set of beams. In either the first beam management case or the second beam management case, the first set of beams and the second set of beams may be in the same frequency or in different frequencies. Additionally, or alternatively, the codebook constructions for the first set of beams and the second set of beams may be configured by the manufacturers of the wireless devices.

For the first beam management case when the UE 115 uses the AI and machine learning models, layer 1 (L1) signaling may be used to report information associated with the AI and machine learning model interference to the network entity 105. The UE 115 may report information such as beams based on the output of the AI and machine learning model inference, predicted L1-reference signal receive power (RSRP) corresponding to the output beams, or other types of information. For the second beam management case when the UE 115 uses the AI and machine learning models, L1-signaling may be used to report information to the network entity 105, such as beams of N future time instances based on the output of the AI or machine learning model inference, the value of N, the predicted L1-RSRPs corresponding to the beams, information (e.g., explicit information or implicit information) about the timestamps corresponding to the reported beams, or any combination thereof.

For both the first beam management case and the second beam management case, when the UE 115 performs model monitoring, the UE 115 may monitor the performance metrics of the AI and machine learning models, make decisions about model selection, activation, deactivation, switching, fallback operations, or any combination thereof. When the network entity 105 performs the model monitoring, the network entity 105 may model the performance metrics of the AI and machine learning models and make decisions for the AI and machine learning models in a similar fashion as the UE 115. In some cases, both devices (e.g., the UE 115 and the network entity 105) may perform model monitoring and the UE 115 may monitor the performance metrics of the AI and machine learning models and the network entity 105 may make decisions about model selection, activation, deactivation, switching, fallback operations, or any combination thereof. In some cases, when the network entity 105 monitors the AI and machine learning models, the network entity 105 may perform beam measurements and generate reports based on the model monitoring.

In some examples of the wireless communications system 100, UEs 115 may communicate with a network entity 105 using transmit beams. To determine which transmit beam(s) to use for communications with the network entity 105, the UE 115 may perform a beam sweeping procedure. During the beam sweeping procedure, the UE 15 may transmit reference signals (e.g., SRSs) using each of the different transmit beams supported by the UE 115, and by measuring these reference signals, the network entity 105 may select a transmit beam for the UE 115. However, traditional beam sweeping techniques are time-consuming and resource heavy. Also, as the number of transmit beams supported by a UE 115, sweeping through all the beams adds to the complexity and increases latency of the beam sweeping procedure. As such, having the UE 115 perform beam sweeping procedures in this manner may be inefficient or in some cases, unsuitable, as technology and UE 115 capabilities improve over time.

Therefore a UE 115 capable of receiving reference signal measurements from the network entity 105 may receive such measurements and use the measurements to predict beams for communicating with the network entity 105. To obtain the reference signal measurements, the UE 115 may transmit SRSs to a network entity and the network entity 105 may perform measurements on the reference signals from the UE 115. The network entity 105 may transmit the reference signal measurements to the UE 115 to aid in performing beam predictions rather than the UE 115 performing beam sweeping across all supported beams to determine an uplink transmission beam. In some cases, the network entity 105 may transmit the reference signal measurements after an SRS transmission, after a time offset, or within a time window. The network entity 105 may also indicate a reference signal measurement corresponding to a specific SRS resource set that may be preconfigured or selected by the UE 115 or the network entity 105. Such reference signal measurement indications may allow the UE 115 to more accurately predict future uplink transmission beams and refraining from having to perform beam sweeping across all beams or randomly choosing beams, which may decrease latency, time, and resource consumption at the UE 115.

FIG. 2 shows an example of a wireless communications system 200 that supports reference signal quality indication for uplink beam prediction in accordance with one or more aspects of the present disclosure. In some examples, the wireless communications system 200 may implement or be implemented by the wireless communications system 100. For example, the wireless communications system 200 may include a UE 115a, and a network entity 105-a which may be examples of corresponding devices described herein with reference to FIG. 1. The UE 115-a may use a set of beams 205 of the UE 115-a to communicate with the network entity 105-a via a communication link 210. The communication link 210 may be examples of a Uu link, a sidelink, a backhaul link, a D2D link or some other type of communication link 125.

In some examples, the network entity 105-a may predict L1-RSRPs for downlink beams and the UE 115-a may predict the associated receiving beam. The UE 115-a may use the predicted beam for subsequent uplink transmissions based on whether the UE 115-a has beam correspondence with the network entity 105-a. In some cases, the beam used for uplink transmissions may use the same spatial filters as the predicted receiving beam, and therefore may the UE 115-a may use the beam for subsequent uplink transmissions with the network entity 105-a.

In some other examples, the prediction of uplink transmit beams may be based on uplink reference signals. In such examples, there may be various benefits in the time domain, spatial domain, and the frequency domain, from using uplink reference signals to predict an uplink transmit beam. For example, in the time domain, when subsequent or future uplink beams (e.g., physical uplink shared channel (PUSCH) transmit beams), the UE 115-a may transmit SRSs 215 less frequently which may reduce signaling overhead and power consumption at the UE. As such, the network entity 105-a may have a more flexible prediction of SRSs and uplink transmission configuration indication (TCI) states or SRS resource indicator predictions. Further, predictions at both the network entity 105-a and the UE 115-a may improve for network entity 105-a guided future uplink-TCI state, SRS resource indicator (SRI), or uplink angle of arrival (AoA) predictions.

In the spatial domain and the time domain, as the SRS 215 transmissions may be spatially sparse which may also lead to reduced signaling overhead and power consumption. Additionally, or alternatively, as a relatively better uplink transmit beam may be predicted, the accuracy and reliability of the UE 115-a may increase. Therefore, the network entity 105-a may be better able to predict indications of linear combinations of SRS resources as an SRI, indications of uplink-AoAs as uplink TCI-states, or both. In the frequency domain, in some examples, uplink transmit beams for higher frequency bands (e.g., FR2/FR4) may be predicted via lower frequency bands (e.g., FR1/FR3) which may lead to better coverage and relatively less radio frequency phase shifting which may lead to reduced power consumption at the UE 115-a. Further, the UE 115-a may use a lower quantity of beams in the lower frequency bands which may lead to reduced signaling overhead when transmitting SRSs 215. For example, using SRS ports in the lower frequency bands may emulate cross-polarization in a higher frequency bands. Further, digital beamforming in the lower frequency bands may also emulate uplink beams in the higher frequency bands. In some cases, indicating lower frequency uplink TCI-state, SRI, uplink-AoA, or any combination thereof may also assist beam predictions at the UE 115-a when scheduling higher frequency uplink messages (e.g., PUSCH).

In some example, the UE 115-b may be a power class three UE 115 and the beam correspondence between the network entity 105-a and the UE 115-a may have some constraints. For example, the constraints may include a UE 115 minimum peak effective isotropic radiated power (EIRP) constraint, a UE 115 spherical coverage constraint, and a beam correspondence tolerance constraint. As such, the beam correspondence constraints may be satisfied based on the UE 115-a satisfying one or more conditions, depending on the UEs 115 beam correspondence capability. For example, if the UE 115-a supports a first parameter (e.g., beamCorrespondance WithoutUL-BeamSweeping) the UE 115-a may meet the minimum peak EIRP constraint and the spherical coverage constraint with uplink beams from the set of beams 205 autonomously selected by the UE 115-a and selected without uplink beam sweeping. As such, the UE 115-a may be considered to have also met the beam correspondence tolerance constraint. In some examples, if the UE 115-b supports the first parameter and a second parameter (e.g., beamCorrespondenceSSB-based-r16), the UE 115-a may meet the minimum peak EIRP constraint and the spherical coverage constraint using side conditions for synchronization signal block (SSB) based enhanced beam correspondence constraints. In some other examples, if the UE 115-b supports the first parameter and a third parameter (e.g., beamCorrespondenceCSI-RS-based-r16), the UE 115-a may meet the minimum peak EIRP constraint and the spherical coverage constraint using side conditions for CSI-RS based enhanced beam correspondence constraints.

In some examples, the UE 115-a may not support the first parameter, as such, if the UE 115-a is unable to support the first parameter, the UE 115-a may meet the minimum peak EIRP constraint and the spherical coverage constraint with uplink beam sweeping. In some other examples, if the UE 115-a is unable to support the first parameter but the UE 115-a does support the second parameter, the UE 115-a may meet the minimum peak EIRP constraint and the spherical coverage constraint with uplink beam sweeping using the side conditions for SSB based enhanced beam correspondence constraints. In another example, if the UE 115-a is unable to support the first parameter but the UE 115-a does support the third parameter, the UE 115-a may meet the minimum peak EIRP constraint and the spherical coverage constraint with uplink beam sweeping using the side conditions for CSI-RS based enhanced beam correspondence constraints. In each example where the UE 115-a may not support the first parameter, the UE 115-a may also meet the beam correspondence tolerance constraint and the UE 115-a may support uplink beam management.

As described, in some cases, the beam correspondence constraints may apply under certain side conditions. For example, the downlink reference signals including both an SSB and CSI-RSs may be provided and a type of QCL (e.g., type D QCL) may be maintained between the SSB and the CSI-RSs. In some examples, a reference measurement channel for beam correspondence may be fulfilled according to a CSI-RS configuration. For beam correspondence, constrains for L1-RSRP measurement may be fulfilled via preconfigured tables at the UE 115-a.

Further, especially when beam correspondence may be unavailable between the network entity 105-a and the UE 115-a, uplink transmit beam sweeping may consume relatively large amounts of power resources and the beam sweeping may cause an increase in latency. In some cases, the UE 115-a may perform uplink transmit beam sweeping through an SRS resource set configured with a beam management usage (e.g., beamManagement) where one of the SRS resources may be activated or switched as a TCI-uplink states reference source. In some other cases, the UE 115-a may perform beam sweeping through an SRS resource set configured with a non-codebook usage (e.g., nonCodebook) where the UE 115-a may change uplink transmit beams for different SRS occasions. Additionally, or alternatively, the L1-RSRP levels for downlink reference signals may be unable to be satisfied by the UE 115-a and the UE 115-a may be unable to apply beam correspondence for uplink transmit beams. Therefore, the UE 115-a may perform a brute-force or random SRS beam sweeping to obtain an appropriate uplink transmit beam or beams from the set of beams 205, which may lead to an increase in power consumption and latency.

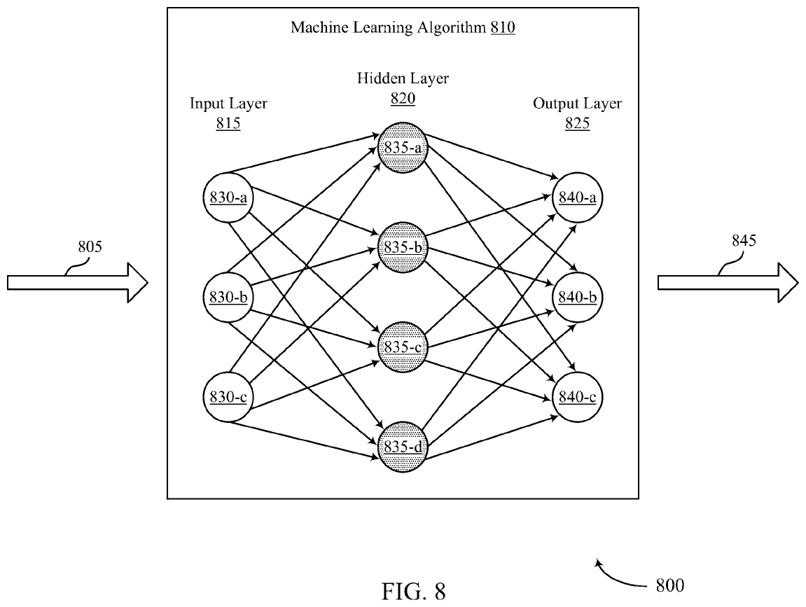

In some examples, instead of the UE 115-a randomly selecting an uplink transmit beam from the set of beams 205, the UE 115-a may predict an uplink transmit beam using SRS-RSRPs (e.g., reference signal measurements 220) measured by the network entity 105-a. The reference signal measurements 220 may be measurements of the SRSs 215 transmitted by the UE 115-a. In some cases, the UE 115-a may also use different SRSs relative or coarse RSRP levels. For example, the UE 115-a may use the reference signal measurements 220 based on historically transmitted SRSs 215 by the UE 115-a and information about the uplink transmit beams as in input to an AI or machine learning model to identify or predict more efficient choices of uplink transmit beams for subsequent SRS transmission occasions. Descriptions of the AI or machine learning model may be described elsewhere herein with reference to FIG. 8.

However, in some examples, the UE 115-a may currently be unable to obtain such information to predict uplink transmit beams for subsequent SRS sweeping or communications. As such, to facilitate more accurate uplink transmit beam predictions at the UE 115-a, the UE 115-a may receive a control signal from the network entity 105-a via the communication link 210 indicating one or more reference signal measurements 220 corresponding to the SRSs 215 transmitted by the UE 115-a. That is, the network entity 105-a may transmit RSRP measurements associated with one or more reference signal resource sets of a set of reference signal resource sets used by the UE 115-a to transmit the SRSs 215. In some cases, the indication may also include reference signal resource identifiers (IDs) (e.g., SRS resource IDs) associated with the reference signal measurements 220 (e.g., SRS-RSRPs).

In some examples, the indication of the reference signal measurements 220 may be for a single reference signal resource set (e.g., a single SRS resource set) of the set of reference signal resource sets. In some other examples, the indication of the reference signal measurements 220 may be for multiple (e.g., two or more) reference signal resource sets of the set of reference signal resource sets. In such examples, the indication should also include reference signal resource set IDs (e.g., SRS resource set IDs) for the respective reference signal resource IDs indicated by the reference signal measurements 220. Further, in some cases, the reference signal resource set indicated via the reference signal measurements 220 by the network entity 105-a may be configured with a specific RRC configured usage (e.g., an SRS-RSRP-r19 usage).

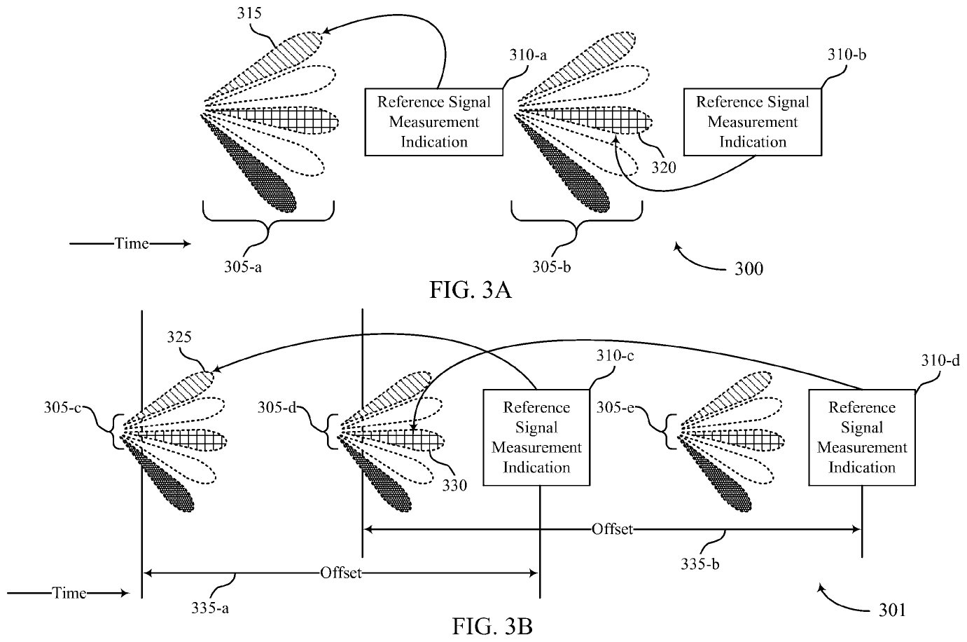

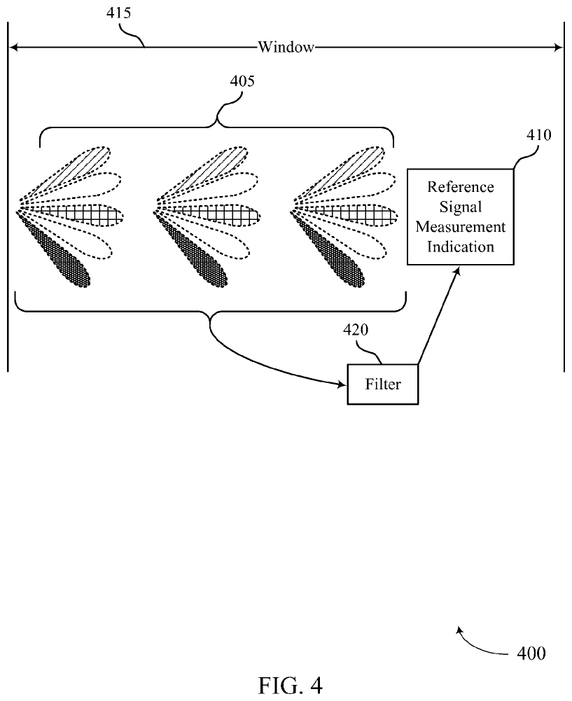

As such, by using the reference signal measurements 220 transmitted from the network entity 105-a, the UE 115-a may identify or predict uplink transmit spatial filters or beams for the UE 115-a to transmit an uplink message. In some cases, the uplink message may be an SRS, a PUSCH message, or a physical uplink control channel (PUCCH) message. Further, the UE 115-a may receive the reference signal measurements 220 via a MAC-control element (MAC-CE) message, an RRC message, an uplink grant downlink control information (DCI) message, a downlink grant DCI, or other types of DCIs. Descriptions of the network entity 105-a using such messages to transmit the reference signal measurements 220 to the UE 115-a via the communication link 210 may be described elsewhere herein including with reference to FIGS. 3-9.

In some cases, the network entity 105-a may transmit the control signal including the two or more reference signal measurements 220 to reduce signaling overhead. In some examples, in an effort to reduce the signaling overhead, the control message may a differential measurement between the reference signal measurements 220. For example, a first reference signal measurement of the reference signal measurements 220 associated with the strongest reference signal resource (e.g., SRS resource) may be quantized absolutely using a first quantity of bits (e.g., N₁ bits). The remaining reference signal measurements of the reference signal measurements 220 associated with the remaining reference signal resources may be quantized differently using a second quantity of bits (e.g., N₂ bits) that may be less than the first quantity of bits (e.g., N₂<N₁). As such, the network entity 105-a may first indicate the reference signal resource ID (e.g., SRS resource ID) associated with the strongest reference signal measurement and then sequentially report the reference signal resource IDs of the remaining reference signal measurements.

In some other examples, the control signal may include an SRS resource indicator (SRI) that may both indicate a combination of SRS resources and identify a ranking or order of the SRS resources. For example, the SRI may indicate the ranking of the SRS resource while omitting the reference signal measurement value of the SRSs. As such, the network entity 105-a may rank or order the SRSs based on the reference signal measurement strengths of the SRSs. In some cases, for a non-codebook (NCB) based SRI with three SRS resources out of four candidate resource, four codepoints may be considered (e.g., {1+2+3, 2+3+4, 1+2+4, 1+2+4}) while the SRI may refrain from considering the inter-resource ranking or order. In some other cases, an SRI with three SRS resources out of four candidate resource may identify 12 codepoints where the strongest SRS resource ID may be represented by being italicized and the remaining SRS resource IDs may remain unordered (e.g., {1+2+3, 2+1+3, 3+1+2, 2+3+4, 3+2+4, 4+2+3, 1+2+4, 2+1+4, 4+1+2, 1+3+4, 3+1+4, 4+1+3}). In another case, an SRI with three SRS resources out of four candidate resource may identify 24 codepoints where each resource ID may be in order from strongest SRS resource to weakest SRS resource.

Further, in some examples, the SRS resources indicated may be associated with reference signal measurements that satisfy a measurement threshold. In some cases, the measurement threshold may be preconfigured by the network entity 105-a or by the UE 115-a. In cases where the measurement threshold may be configured by the network entity 105-a, the network entity 105-a may transmit a message indicating the measurement threshold to the UE 115-a. In other cases, when the measurement threshold may be configured by the UE 115-a, the UE 115-a may transmit the message indicating the measurement threshold to the network entity 105-a. Additionally, or alternatively, it should be understood that such examples may be used in conjunction with each other or on their own.

In some cases, the UE 115-a may predict an uplink transmit beam from the set of beams 205 or uplink transmit spatial filters for a first set of reference signal resource sets based on the network entity 105-a indicating historical reference signal measurements of the first set of reference signal resource sets or a different set. For example, the UE 115-a may be configured with a first reference signal resource set with a first periodicity and a first usage (e.g., usage set to beamManagement) and a second reference signal resource set with a second periodicity and a second usage (e.g., usage set to SRS-RSRP). In some cases, the second periodicity may be longer than the first periodicity, therefore the UE 115-a may predict the uplink transmit beam or uplink spatial filters based on reference signal measurements 220 of the second set of reference signal resource sets. That is, the network entity 105-a may transmit the reference signal measurements 220 based on SRSs from the second set of reference signal resource sets for the UE 115-a to predict an uplink beam from the set of beams 205 to use for transmitting an uplink message with the first set of reference signal resource sets.

In some examples, an RRC configuration of the first reference signal resource set may indicate that the first reference signal resource set may be linked with the second reference signal resource set. In some cases, the quantity of reference signal resources, the periodicity of the reference signal resources, or both within a respective reference signal resource set may be recommended by the UE 115-a. Further, the beams of the set of beams 205 used for the second reference signal resource set may be wider than the beams used for the first reference signal resource set. As such, reference signals may be transmitted more frequently using the second reference signal resource set than the first reference signal resource set. Therefore having the uplink beam prediction for the first reference signal resource set being based on the reference signal measurements 220 of the second reference signal resource set may aid in reducing signaling overhead.

Further, when configured with a non-codebook SRS usage (e.g., nonCodebook or nonCodebook-SRS-RSRP), the UE 115-a may predict uplink transmit beams or spatial filters for a non-codebook based reference signal resource set. The prediction may be based on historical reference signal measurements 220 from the network entity 105-a using the same reference signal resources. That is, the UE 115-a may predict uplink transmit beams for subsequent communications using the same reference signal resources used by the UE 115-a to transmit the SRSs 215 via the communication link 210. As such, the network entity 105-a may use a MAC-CE message or enhanced SRI in uplink grant DCIs to indicate the reference signal measurements 220. For reference signal measurements 220 indicated via a MAC-CE message, the network entity 105-a may periodically indicate filtered reference signal measurements 220 which may aid the UE 115-a in predicting an uplink transmit beam or uplink spatial filters for the reference signal resource set. When the reference signal measurements 220 may be indicated using an SRI through a DCI, the SRI may be associated with the most recent transmission occasion. As such, the UE 115-a may use the coarse reference signal measurements 220 ranks or levels indicated in the SRI to predict the uplink transmit beam or spatial filters for the reference signal resource set. Further, the SRI may add a relatively small amount of overhead to the DCI but the overhead may be negligible.

Using the reference signal measurements 220 from the network entity 105-a, the UE 115-a may be able to predict an uplink transmit beam to use for transmitting an uplink message (e.g., an SRS, a PUCCH message, or a PUSCH message). For example, for a PUSCH message, the UE 115-a may predict the uplink transmit beam or spatial filters for the PUSCH based on reference signal measurements 220 of SRSs 215 of a non-codebook usage (e.g., nonCodebook or nonCodebook-SRS-RSRP). As such, the UE 115-a may use wide beams to transmit the SRSs 215 and may use narrow beams to transmit the PUSCH message based on the reference signal measurements 220 of the reference signal resource set of the SRSs 215 together with an SRI indicated for the scheduled PUSCH. That is, the narrow beams may be predicted based on the reference signal measurements 220. In some cases, the network entity 105-a may indicate the reference signal measurements 220 may via an MAC-CE message and the network entity 105-a may periodically indicate filtered reference signal measurements 220 of the reference signal resources in an NCB reference signal resource set through the MAC-CE message. In some other cases, the network entity 105-a may indicate the reference signal measurements 220 via an SRI through a DCI where the SRI may be associated with the most recent reference signal transmission occasion and may be indicated in an uplink grant DCI used to schedule the PUSCH.

For other uplink messages (e.g., SRS, PUSCH message, or PUCCH message) the UE 115-a may predict uplink transmit beams or spatial filters for the uplink messages based on TCI uplink states associated with the uplink message and the historical reference signal measurements 220 indicated by the network entity 105-a. In some cases, the reference signal measurements 220 may be based on SRSs 215 transmitted by the UE 115-a using an reference signal resource set with a reference signal usage (e.g., usage may be set to beamManagement or SRS-RSRP). The network entity 105-a may indicate the reference signal measurements 220 using a MAC-CE message or an SRI (e.g., in a downlink grant switching an uplink or unified TCI state). In such cases, the UE 115-a may transmit the SRSs 215 via wide beams and the TCI uplink state may be associated with the reference signal resources of the SRSs 215 in an associated reference signal resource set. The UE 115-a may then predict narrow beams for transmitting the uplink messages based on the TCI uplink state the UE 115-a switched to for the UE 115-a to transmit the uplink messages together with the reference signal measurements 220. In some cases, the UE 115-a may receive the SRI via a downlink grant DCI (or via RRC or MAC-CE) indicating to switch to a different uplink TCI state to transmit the uplink messages.

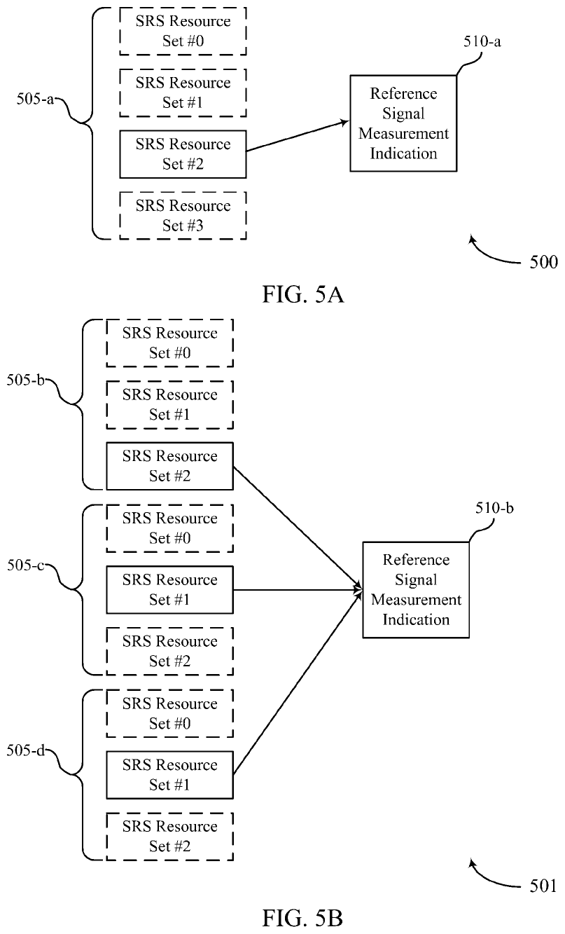

Therefore, using the reference signal measurements 220, the UE 115-a may more accurately predict uplink beams for transmitting uplink messages and the beam prediction procedure may reduce signaling overhead by preventing the UE 115-a from performing brute-force or random beam sweeping. Further descriptions of the UE 115-a using the reference signal measurements 220 based on SRSs 215 transmitted by the UE 115-a to predict uplink beams of the set of beams 205 may be described elsewhere herein including with reference to FIG. 3A9. For example, descriptions of how the reference signal measurements 220 may generated may be described with reference to FIGS. 3A-4. Descriptions of selecting which reference signal resource set to be used for generating the reference signal measurements 220 may be described with reference to FIG. 5A7.

FIGS. 3A and 3B show an example of a beam measurement timing diagram 300 and a beam measurement timing diagram 301 that supports reference signal quality indication for uplink beam prediction in accordance with one or more aspects of the present disclosure. In some examples, the beam measurement timing diagram 300 and the beam measurement timing diagram 301 may be implemented by or may implement the wireless communications system 100 or the wireless communications system 200. For example, the beam measurement timing diagram may include sets of beams 305 (e.g., a set of beams 305-a, a set of beams 305-b, a set of beams 305-c, a set of beams 305-d, or a set of beams 305-e) used by wireless devices such as UEs 115 to transmit SRSs to network entities 105 which may be examples of devices described herein.

In some examples, a UE 115 may receive a reference signal measurement indication 310 (e.g., a reference signal measurement indication 310-a, a reference signal measurement indication 310-b, a reference signal measurement indication 310-c, or a reference signal measurement indication 310-d) from a network entity 105. The reference signal measurement indication 310 may indicate a reference signal measurement and the associated reference signal resource IDs for a single reference signal transmission occasion (e.g., SRS transmission occasion) associated with the reference signal resource IDs (e.g., SRS resource IDs). In some cases, the reference signal transmission occasion may include a UE 115 transmitting a set of reference signals using a set of beams from the sets of beams 305 of the UE 115. As such, the reference signal measurement indication 310 may indicate a beam (e.g., a first beam 315 or a second beam 320) for the UE 115 to use to transmit an uplink message As illustrated via FIG. 3A, the reference signal measurement indication 310 (e.g., the reference signal measurement indication 310-a or the reference signal measurement indication 310-b) may correspond to the most recently transmitted SRS. For example, the reference signal measurement indication 310-a may indicate that the UE 115 should use the first beam 315 for transmitting an uplink message. That is, the UE 115 may transmit a set of reference signals using the set of beams 305-a and based on a beam prediction procedure and the reference signal measurement indication 310-a, the UE 115 may select the first beam 315 for transmitting an uplink message. In some cases, the reference signal measurement indication 310-a may correspond to the last transmission occasion (e.g., the transmission occasion using the set of beams 305-a) before a set of time resources allocated for a control signal including the reference signal measurement indication 310-a. As such, the network entity 105 may transmit the control signal including reference signal measurement indication 310-a based on reference signal measurements occurring directly before the set of time resource allocated for the control signal. In such cases, the UE 115 may transmit a first set of reference signals via the set of beams 305-a and then wait for the reference signal measurement indication 310-a before transmitting an uplink message or transmitting a second set of reference signals via the set of beams 305-b. Therefore, the UE 115 may receive the most accurate and up-to-date reference signal measurement indication 310.

As illustrated in FIG. 3B, the reference signal measurement indication 310 (e.g., the reference signal measurement indication 310-c or the reference signal measurement indication 310-d) may be transmitted to the UE 115 according to a time domain offset 335 (e.g., a time domain offset 335-a or a time domain offset 335-b). As such, the reference signal measurement indication 310 may indicate a beam (e.g., a first beam 325 or a second beam 330) for the UE 115 to use to transmit an uplink message. For example, the UE 115 may transmit the set of reference signals using the set of beams 305-c and then after the time domain offset 335-a the network entity 105 may transmit the reference signal measurement indication 310-c. After receiving the reference signal measurement indication 310-c, the UE 115 may use the reference signal measurement indication 310-c as part of a beam prediction procedure to select the first beam 325 of the set of beams 305-c for transmitting an uplink message.

As such, the resource signal measurements and the corresponding resource signal IDs may be associated with the reference signal resources transmitted with the time domain offset 335. In some cases, the time domain offset 335 may be a set of slots between a reference signal transmission occasion and the transmission of the reference signal measurement indication 310. Further, the time domain offset 335 may be preconfigured, preconfigured via an RRC message, indicated to the UE 115 via a MAC-CE message, or recommended by the UE 115. In some cases, the UE 115 may transmit multiple sets of reference signals within the time domain offset 335-a. For example, the UE 115 may transmit a first set of reference signals via the set of beams 305-c and a second set of reference signal via the set of beams 305-d within the time domain offset 335-a. As such, the UE 115 may refrain from waiting for a reference signal measurement indication 310 before transmitting an uplink message or the second set of reference signals. Therefore, there may be a reduction in latency when waiting to receive a reference signal measurement indication 310 after the time domain offset 335.

While FIGS. 3A and 3B illustrate a reference signal measurement indication 310 being based on a single reference signal transmission occasion, in some cases the UE 115 may receive a reference signal measurement indication 310 based on two or more reference signal transmission occasions. Further description of receiving a reference signal measurement indication 310 based on two or more reference signal transmission resource sets may be described with reference to FIG. 4.

FIG. 4 shows an example of a beam measurement timing diagram 400 that supports reference signal quality indication for uplink beam prediction in accordance with one or more aspects of the present disclosure. In some examples, the beam measurement timing diagram 400 may be implemented by or may implement the wireless communications system 100 or the wireless communications system 200. For example, the beam measurement timing diagram 400 may include a multiple set of beams 405 used by wireless devices such as UEs 115 to transmit SRSs to network entities 105 which may be examples of devices described herein.

In some examples, the UE 115 may transmit reference signals via two or more reference signal resource sets using the multiple set of beams 405 withing a time domain window 415. In such examples, the UE 115 may receive a reference signal measurement indication 410 from the network entity 105 including reference signal measurements and the corresponding reference signal resource IDs based on a set of reference signals transmitted by the UE 115 via the two or more reference signal resource sets in a time domain window 415. Further, the network entity 105 may filter the reference signal measurements according to a filter 420 for a filtering scheme. That is, the network entity 105 may average the reference signal measurements based on the reference signals transmitted by the UE 115 via the multiple set of beams 405 within the time domain window 415. As such, the reference signal measurement indication 410 may include a single reference signal measurement that may be averaged across the reference signal measurements from the multiple set of beams 405 In some cases, the filter 420 and the corresponding filtering scheme may be predefined, configured by the network entity 105, indicated within the reference signal measurement indication 410, or indicated to the UE 115 via a separate message. Further the filtering scheme may also include one or more additional parameters. For example, the filtering scheme may include a time domain window 415 length, a starting and ending point of the time domain window 415 applied to the filter 420, a filtering algorithm used by the filtering scheme.

In some examples, when transmitting the reference signals via the multiple set of beams 405, the UE 115 may use the same uplink transmit spatial filters for each set of beams within the multiple set of beams 405. In some cases, the network entity 105 may request the UE 115, the UE 115 may indicate to the network entity 105, or the UE 115 may be preconfigured to use the same uplink transmit spatial filters for each set of beams within the multiple set of beams 405. In some other examples, the time domain window 415 may be infinite and the UE 115 may use the uplink transmit spatial filters for transmitting all reference signals within the time domain window 415. In some cases, the UE 115 or the network entity 105 may select or determine which reference signal resource sets to use and such selections or determinations may be described with reference to FIGS. 5A through 7.

FIGS. 5A and 5B show an example of a resource selection diagram 500 and a resource selection diagram 501 that supports reference signal quality indication for uplink beam prediction in accordance with one or more aspects of the present disclosure. In some examples, the resource selection diagram 500 and the resource selection diagram 501 may be implemented by or may implement the wireless communications system 100 or the wireless communications system 200. For example, the resource selection diagram 500 and the resource selection diagram 501 may include sets of reference signal resource sets 505 (e.g., a set of reference signal resource sets 505-a, a set of reference signal resource sets 505-b, a set of reference signal resource sets 505-c, and a set of reference signal resource sets 505-d). The sets of reference signal resource sets 505 may be used by a UE 115 to transmit reference signals to a network entity 105 to transmit a reference signal measurement indication 510 (e.g., a reference signal measurement indication 510-a and a reference signal measurement indication 510-b). In some cases, the UE 115 and the network entity 105 may be examples of devices described herein including with reference to FIGS. 1 and 2.

As described herein, the UE 115 may transmit reference signals using candidate sets of reference signal resource sets 505. For example, as illustrated via FIG. 5A, the UE 115 may transmit reference signals using the set of reference signal resource sets 505-a that includes a first reference signal resource set (e.g., SRS resource set #0), a second reference signal resource set (e.g., SRS resource set #1), a third reference signal resource set (e.g., SRS resource set #2), and a fourth reference signal resource set (e.g., SRS resource set #3). Further, in some examples each of the reference signal resource sets in the set of reference signal resource sets 505-a may be configured with the same usage (e.g., SRS-RSRP usage). In some cases, the UE 115 may be preconfigured that the reference signal measurement indication 510 may be for a single reference signal resource set from the set of reference signal resource sets 505-a. For examples, the configuration may indicate that the reference signal measurement indication 510 may be a measurement of the third reference signal resource set of the set of reference signal resource sets 505-a. In some cases, the third reference signal resource set may be selected over the first two reference signal resource sets based on the third reference signal resource set with a higher signal quality compared to the other reference signal resource sets of the set of reference signal resource sets 505-a. Therefore the reference signal measurement indication 510-a may include measurements corresponding to the third reference signal resource set.

In some other examples, as illustrated via FIG. 5B, the UE 115-a may receive a configuration or indication from the network entity 105 indicating which reference signal resource set of a sets of reference signal resource sets 505 may be used for the reference signal measurement indication 510-b. In FIG. 5B, the set of reference signal resource sets 505-b, the set of reference signal resource sets 505-c, and the set of reference signal resource sets 505-d may each include a respective first reference signal resource set, a second reference signal resource set, and a third reference signal resource set. Further, the sets of reference signal resource sets 505 illustrated in FIG. 5B may be configured with different reference signal usages (e.g., beamManagement, nonCodebook, or SRS-RSRP-r19 usages). As such, the UE 115 may receive an RRC, MAC-CE, or DCI message to indicate which reference signal resources sets (e.g., candidate reference signal resource sets) may be addressed in the reference signal measurement indication 510-b.

For example, the message may indicate that the third reference signal resource set of the set of reference signal resource sets 505-b, the second reference signal resource set of both the set of reference signal resource sets 505-c and of the set of reference signal resource sets 505-d may be addressed in the reference signal measurement indication 510-b. That is, the reference signal measurement indication 510-b may include measurements from multiple reference signal resource sets. In some cases, when the UE 115 receives the reference signal measurement indication 510-b via a DCI message, the DCI message may be linked with a DCI format or a radio network temporary identifier (RNTI). In some other cases, when the UE 115 received the reference signal measurement indication 510-b via a MAC-CE message, the MAC-CE message may be linked with a MAC-CE ID.

In some examples, when the UE 115 receives the reference signal measurement indication 510-b, the network entity 105 may indicate that the reference signal measurements indicated may correspond to one of the sets of reference signal resource sets 505 or a specific usage. For example, the network entity 105 may indicate that the reference signal measurements may correspond to reference signal resource sets with the beam management usage. Additionally, or alternatively, the network entity 105 may indicate that the reference signal measurements may correspond to one or more reference signal resource sets. In some cases, the one or more reference signal resource sets may be from one of the sets of reference signal resource sets 505 of the selected usage. In some other examples, the network entity 105 may indicate that the reference signal measurements may correspond to at least on reference signal resource set form each of the sets of reference signal resource sets 505 configured.

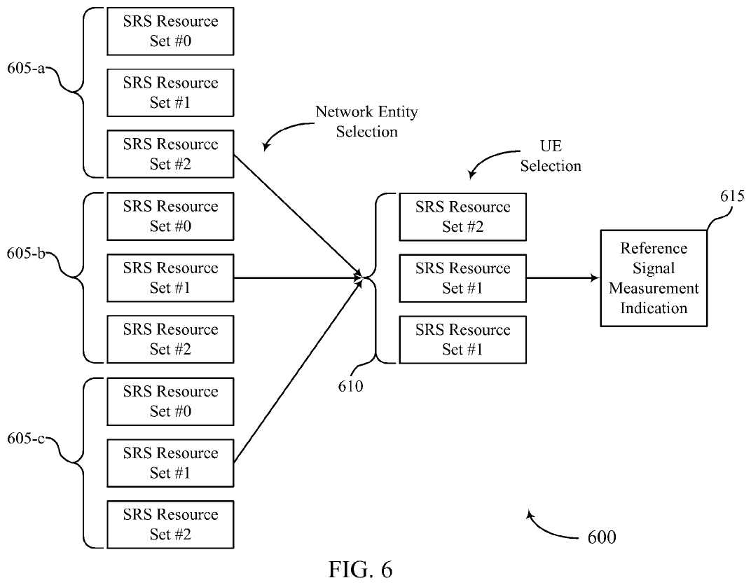

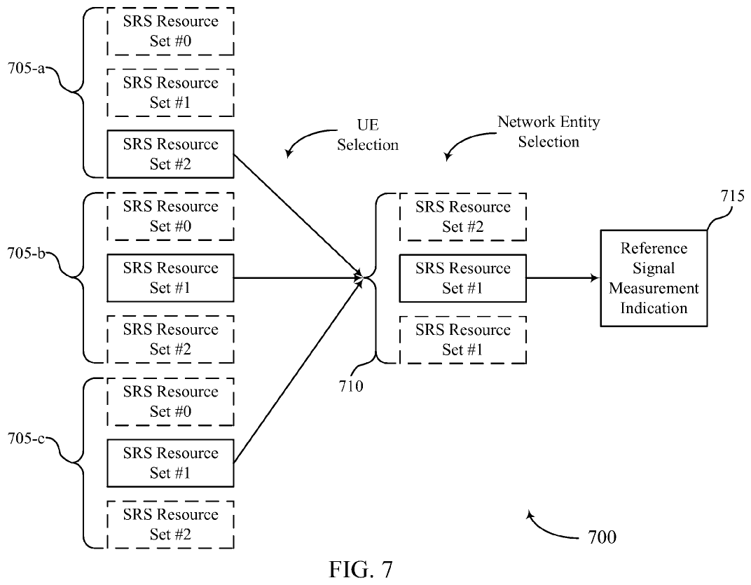

Further, the network entity 105 may indicate a quantity of reference signal resource sets, a quantity of reference signal resources per each reference signal resource set, a total quantity of reference signal measurements, or any combination thereof that may be associated with the reference signal measurement indication 510-b. In some cases, the network entity 105 may transmit such indications to the UE 115. In some other cases, the information may be preconfigured between the network entity 105 and the UE 115 prior to communications. In some cases, when the network entity 105 uses a MAC-CE message to transmit the reference signal measurement indication 510-b, the MAC-CE message may also include the reference signal resource sets and other information associated with the reference signal measurement indication 510-b. Additionally, or alternatively, the network entity 105 and the UE 115 may coordinate together to select the reference signal resource sets used for the reference signal measurement indication 510, which may be described with reference to FIGS. 6 and 7.

FIG. 6 shows an example of a resource selection diagram 600 that supports reference signal quality indication for uplink beam prediction in accordance with one or more aspects of the present disclosure. In some examples, the resource selection diagram 600 may be implemented by or may implement the wireless communications system 100 or the wireless communications system 200. For example, the resource selection diagram 600 may include sets of reference signal resource sets 605 (e.g., a set of reference signal resource sets 605-a, a set of reference signal resource sets 605-b, and a set of reference signal resource sets 605-c) and a selected set of reference signal resource sets 610. Further, the sets of reference signal resource sets 605 may be set with different reference signal usages (e.g., beamManagement, nonCodebook, or SRS-RSRP-r19 usages). As such, sets of reference signal resource sets 605 and the selected set of reference signal resource sets 610 may be used by a UE 115 to transmit reference signals to a network entity 105 to transmit a reference signal measurement indication 615. In some cases, the UE 115 and the network entity 105 may be examples of devices described herein including with reference to FIGS. 1 and 2.

In some examples, before the network entity 105 transmits the reference signal measurement indication 615, the UE 115 may request which reference signal resource set the network entity 105 should measure and which reference signal resource set the reference signal measurement indication 615 may correspond to. That is, the UE 115 may transmit a message to the network entity 105 requesting the network entity 105 to measure a specific reference signal resource set. In some cases, before the UE 115 transmits the request message to the network entity 105, the network entity 105 may transmit a message to the UE 115 indicating a reference signal set from the set of reference signal resource sets 605-a, the set of reference signal resource sets 605-b, and the set of reference signal resource sets 605-c. For example, the network entity 105 may select the third reference signal resource set from the set of reference signal resource sets 605-a and the second reference signal resource set from the set of reference signal resource sets 605-b and the set of reference signal resource sets 605-c. As such, the reference signal resource sets may form the selected set of reference signal resource sets 610 for the UE 115 to further select (e.g., down-select) a single reference signal resource set to be measured for the reference signal measurement indication 615. In some cases, the reference signal resource sets indicated by the network entity 105 that make up the selected set of reference signal resource sets 610 may be the reference signal resource sets with the strongest reference signal resources. Additionally, or alternatively, the selection from the network entity 105 may be based on all the sets of reference signal resource sets 605 or based on the currently active sets of reference signal resource sets 605.

As such, after the UE 115 receives the selected set of reference signal resource sets 610, the UE 115 may further select the second reference signal resource set from the selected set of reference signal resource sets 610 to be addressed in the reference signal measurement indication 615. Therefore, the UE 115 may indicate to the network entity 105 to measure and transmit the reference signal measurement indication 615 based on the second reference signal resource set of the selected set of reference signal resource sets 610. In some cases, such indication may be transmitted using an uplink MAC-CE message. The UE 115 may refrain from using an uplink control information (UCI) message to avoid any ambiguity issues with other uses of an UCI message. As such, the network entity 105 may generate and transmit the reference signal measurement indication 615 to the UE 115 using the reference signal resource set requested by the UE 115. In some examples, as the UE 115 may have selected which reference signal resource set the reference signal measurement indication 615 may be associated with, the network entity 105 may refrain from transmitting any reference signal resource IDs to reduce the signaling overhead of the reference signal measurement indication 615. Therefore, having the UE 115 indicate which reference signal resource set the reference signal measurement indication 615 may be associated with may reduce signaling overhead and allow the UE 115 to proactively control what measurements may be given as in input to the beam prediction procedure described with reference to FIG. 8. In some other examples, the UE 115 may select one or more reference signal resource sets for the network entity 105 to select from, such examples may be described with reference to FIG. 7.

FIG. 7 shows an example of a resource selection diagram 700 that supports reference signal quality indication for uplink beam prediction in accordance with one or more aspects of the present disclosure. In some examples, the resource selection diagram 700 may be implemented by or may implement the wireless communications system 100 or the wireless communications system 200. For example, the resource selection diagram 700 may include sets of reference signal resource sets 705 (e.g., a set of reference signal resource sets 705-a, a set of reference signal resource sets 705-b, and a set of reference signal resource sets 705-c) and a selected set of reference signal resource sets 710. Further, the sets of reference signal resource sets 705 may be set with different reference signal usages (e.g., beamManagement, nonCodebook, or SRS-RSRP-r19 usages). The sets of reference signal resource sets 705 and the selected set of reference signal resource sets 710 may be used by a UE 115 to transmit reference signals to a network entity 105 to transmit a reference signal measurement indication 715. In some cases, the UE 115 and the network entity 105 may be examples of devices described herein including with reference to FIGS. 1 and 2.

In some examples, similar to as described with reference to FIG. 6, before the network entity 105 transmits the reference signal measurement indication 715, the UE 115 may request which reference signal resource sets the network entity 105 should measure and which reference signal resource set the reference signal measurement indication 715 may correspond to. That is, the UE 115 may transmit a message to the network entity 105 requesting the network entity 105 to measure a specific reference signal resource set. However, in some cases, the network entity 105 may receive such request message from the UE 115 before the network entity 105 selects an indication of reference signal resource sets.

For example, the UE 115 may transmit indications of the third reference signal resource set of the set of reference signal resource sets 705-a and the second reference signal resource set of the set of reference signal resource sets 705-b and the set of reference signal resource sets 705-c. As such, the reference signal resource sets indicated by the UE 115 may form the selected set of reference signal resource sets 710. That is, the request message from the UE 115 may indicate that the network entity 105 should select at least one of the reference signal resource sets from the selected set of reference signal resource sets 710 for the reference signal measurement indication 715. Following the network entity 105 receiving the request message from the UE 115, the network entity 105 may select a reference signal resource set from the selected set of reference signal resource sets 710 (e.g., the second reference signal resource set of the selected set of reference signal resource sets 710) to be used for the reference signal measurement indication 715.

In such cases, the network entity 105 may transmit separately or within the reference signal measurement indication 715 an indication of which reference signal resource set of the selected set of reference signal resource sets 710 the network entity 105 selected (e.g., the reference signal resource IDs). Such message may further aid the UE 115 in using the reference signal measurement indication 715 for beam predictions. As such, while the network entity 105 may select which reference signal resource set may be used for the reference signal measurement indication 715, the initial request message from the UE 115 may ensure that the reference signal measurement indication 715 may include at least one of the UE 115 initial reference signal resource set selections. Therefore, the UE 115 may receive the reference signal measurement indication 715 and use the information indicated in the reference signal measurement indication 715 as input for the beam prediction procedure using AI, machine learning models, or both, which may be described elsewhere herein including with reference to FIG. 8.

FIG. 8 shows an example of a machine learning diagram 800 that supports beam pair information reporting in accordance with one or more aspects of the present disclosure. The machine learning process may be implemented by the wireless communications system 100 or the wireless communications system 200 with reference to FIGS. 1 and 2. For example, the machine learning diagram 800 may be implemented at a network entity 105, or a UE 115, or both as described with reference to FIGS. 1 and 2.

The machine learning diagram 800 may include a machine learning algorithm 810. As illustrated, the machine learning algorithm 810 may be an example of a neural network, such as a feed forward (FF) or deep feed forward (DFF) neural network, a recurrent neural network (RNN), a long/short term memory (LSTM) neural network, or any other type of neural network. However, any other machine learning algorithms may be supported. For example, the machine learning algorithm 810 may implement a nearest neighbor algorithm, a linear regression algorithm, a Naïve Bayes algorithm, a random forest algorithm, or any other machine learning algorithm. Furthermore, the machine learning diagram 800 may involve supervised learning, unsupervised learning, semi-supervised learning, reinforcement learning, or any combination thereof.

The machine learning algorithm 810 may include an input layer 815, one or more hidden layers 820, and an output layer 825. In a fully connected neural network with one hidden layer 820, each hidden layer node 835 may receive a value from each input layer node 830 as input, where each input may be weighted. These neural network weights may be based on a cost function that is revised during training of the machine learning algorithm 810. Similarly, each output layer node 880 may receive a value from each hidden layer node 835 as input, where the inputs are weighted. If post-deployment training (e.g., online training) is supported, memory may be allocated to store errors and/or gradients for reverse matrix multiplication. These errors and/or gradients may support updating the machine learning algorithm 810 based on output feedback. Training the machine learning algorithm 810 may support computation of the weights (e.g., connecting the input layer nodes 830 to the hidden layer nodes 835 and the hidden layer nodes 835 to the output layer nodes 880) to map an input pattern to a desired output outcome. This training may result in a device-specific machine learning algorithm 810 based on the historic application data and data transfer for a specific network entity 105 or UE 115.

In some examples, input values 805 may be sent to the machine learning algorithm 810 for processing. Such input values 805 may include one or more reference signal measurements of a set of SRSs corresponding to one or more reference signal resource sets of a set of reference signal resources sets used to transmit the set of SRSs. In some example, preprocessing may be performed according to a sequence of operations on the input values 805 such that the input values 805 may be in a format that is compatible with the machine learning algorithm 810. The input values 805 may be converted into a set of k input layer nodes 830 at the input layer 815. In some cases, different measurements may be input at different input layer nodes 830 of the input layer 815. Some input layer nodes 830 may be assigned default values (e.g., values of 0) if the number of input layer nodes 830 exceeds the number of inputs corresponding to the input values 805. As illustrated, the input layer 815 may include three input layer nodes 830-a, 830-b, and 830-c. However, it is to be understood that the input layer 815 may include any number of input layer nodes 830 (e.g., 20 input nodes).

The machine learning algorithm 810 may convert the input layer 815 to a hidden layer 820 based on a number of input-to-hidden weights between the k input layer nodes 830 and the n hidden layer nodes 835. The machine learning algorithm 810 may include any number of hidden layers 820 as intermediate steps between the input layer 815 and the output layer 825. Additionally, each hidden layer 820 may include any number of nodes. For example, as illustrated, the hidden layer 820 may include four hidden layer nodes 835-a, 835-b, 835-c, and 835-d. However, it is to be understood that the hidden layer 820 may include any number of hidden layer nodes 835 (e.g., 10 input nodes). In a fully connected neural network, each node in a layer may be based on each node in the previous layer. For example, the value of hidden layer node 835-a may be based on the values of input layer nodes 830-a, 830-b, and 830-c (e.g., with different weights applied to each node value).

The machine learning algorithm 810 may determine values for the output layer nodes 840 of the output layer 825 following one or more hidden layers 820. For example, the machine learning algorithm 810 may convert the hidden layer 820 to the output layer 825 based on a number of hidden-to-output weights between the n hidden layer nodes 835 and the m output layer nodes 880. In some cases, n=m. Each output layer node 840 may correspond to a different output value 885 of the machine learning algorithm 810. The output values 845 may indicate one or more beam pair predictions, such that the network entity (e.g., using the machine learning algorithm 810) may indicate such predictions to a UE. As illustrated, the machine learning algorithm 810 may include three output layer nodes 840-a, 840-b, and 840-c, supporting three different threshold values. However, it is to be understood that the output layer 825 may include any number of output layer nodes 840. In some examples, post-processing may be performed on the output values 845 according to a sequence of operations such that the output values 845 may be in a format that is compatible with reporting the output values 845.

In this way, the network entity may receive the report from the UE and input the non-zero values of the report into the machine learning algorithm 810 as input values 805. The network entity may use the machine learning algorithm to determine one or more output values 845, where such output values 845 indicate uplink beams for the UE for subsequent communications. As such, the network entity may utilize the machine learning algorithm 810 to perform beam prediction procedures efficiently and accurately.

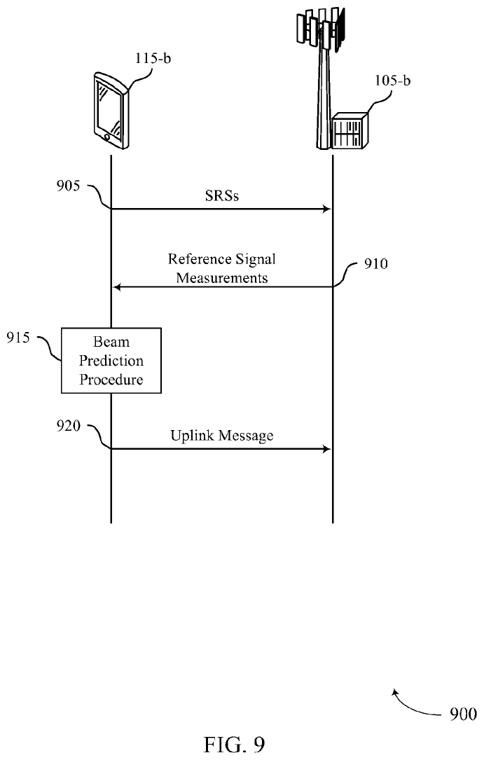

FIG. 9 shows an example of a process flow 900 that supports reference signal quality indication for uplink beam prediction in accordance with one or more aspects of the present disclosure. In some examples, the process flow 900 may implement or be implemented by the wireless communications system 100 or the wireless communications system 200. For example, the process flow 900 may include a UE 115-b and a network entity 105-b which may be examples of devices described herein with reference to FIG. 1

In the following description of the process flow 900, the operations between the UE 115-b and the network entity 105-b may be performed in different orders or at different times. Some operations may also be left out of the process flow 900, or other operations may be added. Although the UE 115-b and the network entity 105-b are shown performing the operations of the process flow 900, some aspects of some operations may also be performed by one or more other wireless devices.

At 905, the UE 115-b may transmit, to the network entity 105-b, a set of SRSs via a set of reference signal resource sets using a set of beams of the UE 115-b. At 910, the UE 115-b may receive, from the network entity 105-b a control signal indicating one or more reference signal measurements corresponding to one or more reference signal resource set of the set of reference signal resource sets. The one or more reference signal measurement being based on the set of SRSs transmitted at 905.

In some cases, the UE 115-b may receive control signal including respective reference signal resource IDs corresponding to the one or more reference signal measurements. The respective reference signal resource IDs associated with at least on reference signal resource set of the set of reference signal resource sets. In some examples, the control signal indicating a reference signal measurement of an SRS may be associated with a reference signal transmission occasion. The reference signal transmission occasion may have been the last reference signal transmission occasion before a set of time resource allocated for the control signal. That is, the reference signal measurement may be based on the last SRS by the UE 115-b before the UE 115-b receives the control signal. In some other examples, the UE 115-b may receive the control signal according to a time domain offset. The time domain offset may indicate a time duration between the transmission of the set of SRSs and a set of time resources allocated for the control signal. Additionally, or alternatively, the control signal indicating the one or more reference signal measurements may correspond to two or more reference signal resource sets of the set of reference signal resource sets. The two or more reference signal resource sets may be within a time window associated with a filtering scheme associated with the one or more reference signal measurements. That is, the two or more reference signal resources may be filtered via the filtering scheme and the one or more reference signal measurements may be based on the filtered reference signal resource.

In some cases, before receiving the control signal, the UE 115-b may receive a second control signal indicating that measurements for at least one of the one or more reference signal resource sets is to be included in the control signal from the network entity 105-b at 910. In some other cases, the UE 115-b may transmit, to the network entity 105-b, a request for the network entity 105-b to include measurements for at least one of the one or more reference signal resource sets in the control signal at 910. Additionally, or alternatively, the UE 115-b and the network entity 105-b may communicate (e.g., the UE 115-b or the network entity 105-b may transmit or receive), before receiving the control signal at 910, an indication of a measurement threshold where the one or more reference signal measurements indicated in the control signal satisfy the measurement threshold.

In some examples, the UE 115-b may receive a first set of bits indicating a first measurement of a first reference signal resource set of the set of reference signal resource sets, in the control message. The UE 115-b may also receive a second set of bits in the control message indication a differential measurement relative to the first measurement indicating a quantized differential between the first measurement and a second measurement. In some cases, a quantity of bits in the first set of bits may be greater than a quantity of bits in the second set of bits. In some other examples, the control signal may include an SRI indicating the one or more reference signal resource sets according to an order based on the one or more reference signal measurements (e.g., from strongest measurement to weakest measurement). In some cases, the one or more reference signal measurements may correspond to a first reference signal resource set associated with a first periodicity. In some other cases, the control signal may indicate one or more reference signal measurements corresponding to the first reference signal resource set of the set of reference signal resource sets. Further, the control signal may be received via a MAC-CE message, an RRC message, an uplink grant DCI message, or a downlink grant DCI message.

At 915, the UE 115-b may perform a beam prediction procedure based on the one or more reference signal measurements corresponding to the one or more reference signal resource sets. The UE 115-b may use the beam prediction procedure to obtain an uplink beam of the UE for transmission of an uplink message to the network entity 105-b. In some cases, when the one or more reference signal measurements may correspond to the first reference resource set associated with the first periodicity, the UE 115-b may obtain the uplink the uplink beam for transmission of an uplink message via a second reference signal resource set different from the first reference signal resource set. In some cases, the uplink message may include an SRS different from and not included in the set of SRSs transmitted at 905. In some other cases, when the one or more reference signal measurements correspond to a first reference signal resource set, the UE 115-b may perform the beam prediction procedure using the one or more reference signal measurements corresponding to the first reference signal resource set to predict an uplink beam of the UE 115-b for subsequent communications. In some examples, the UE 115-b may use the predicted uplink beam for subsequent communications using the first reference signal resource set.

At 920, the UE 115-b may transmit, to the network entity 105-b, the uplink message using the uplink beam of the UE based on the beam prediction procedure. That is, the UE 115-b may use the predicted uplink beam for transmitting the uplink message. In some cases, the UE 115-b may receive, from the network entity 105-b, a second control signal indicating a switch from a first TCI state to a second TCI state for transmitting the first message. As such, the UE 115-b may transmit the uplink message based on the second TCI state.

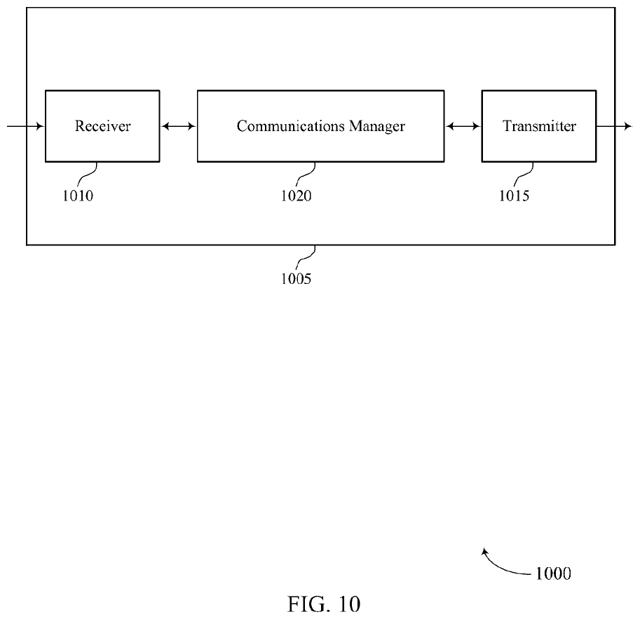

FIG. 10 shows a block diagram 1000 of a device 1005 that supports reference signal quality indication for uplink beam prediction in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to reference signal quality indication for uplink beam prediction). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to reference signal quality indication for uplink beam prediction). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of reference signal quality indication for uplink beam prediction as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. For example, the communications manager 1020 is capable of, configured to, or operable to support a means for transmitting, to a network entity and using a set of multiple beams of the UE, a set of multiple SRSs via a set of multiple reference signal resource sets. The communications manager 1020 is capable of, configured to, or operable to support a means for receiving, from the network entity, a control signal indicating one or more reference signal measurements corresponding to one or more reference signal resource sets of the set of multiple reference signal resource sets based on the set of multiple SRSs. The communications manager 1020 is capable of, configured to, or operable to support a means for performing, based on the one or more reference signal measurements corresponding to the one or more reference signal resource sets, a beam prediction procedure to obtain an uplink beam of the UE for transmission of an uplink message to the network entity. The communications manager 1020 is capable of, configured to, or operable to support a means for transmitting, to the network entity, the uplink message using the uplink beam of the UE based on the beam prediction procedure.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for using reference signal measurements for a beam prediction procedure for reduced processing, reduced power consumption, and more efficient utilization of communication resources.

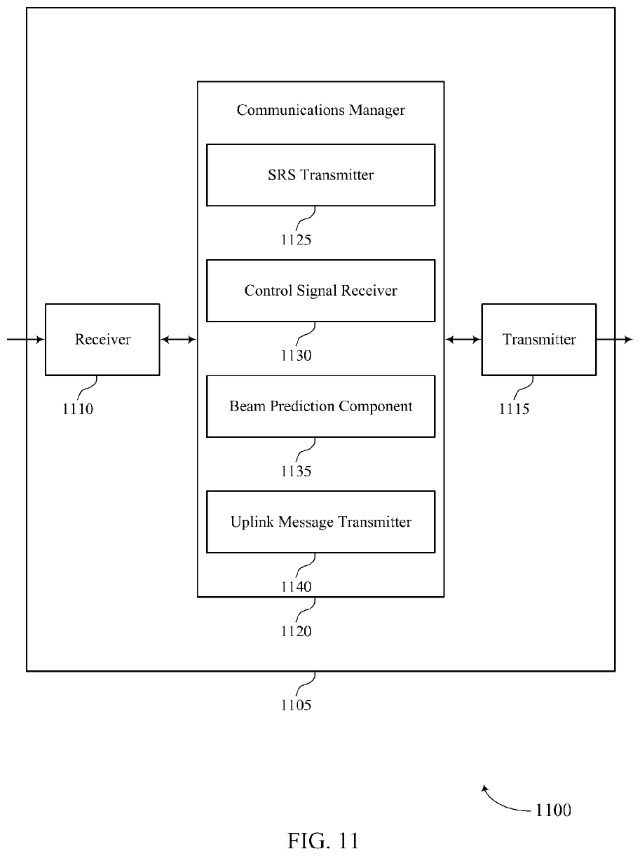

FIG. 11 shows a block diagram 1100 of a device 1105 that supports reference signal quality indication for uplink beam prediction in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to reference signal quality indication for uplink beam prediction). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to reference signal quality indication for uplink beam prediction). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of reference signal quality indication for uplink beam prediction as described herein. For example, the communications manager 1120 may include an SRS transmitter 1125, a control signal receiver 1130, a beam prediction component 1135, an uplink message transmitter 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a UE in accordance with examples as disclosed herein. The SRS transmitter 1125 is capable of, configured to, or operable to support a means for transmitting, to a network entity and using a set of multiple beams of the UE, a set of multiple SRSs via a set of multiple reference signal resource sets. The control signal receiver 1130 is capable of, configured to, or operable to support a means for receiving, from the network entity, a control signal indicating one or more reference signal measurements corresponding to one or more reference signal resource sets of the set of multiple reference signal resource sets based on the set of multiple SRSs. The beam prediction component 1135 is capable of, configured to, or operable to support a means for performing, based on the one or more reference signal measurements corresponding to the one or more reference signal resource sets, a beam prediction procedure to obtain an uplink beam of the UE for transmission of an uplink message to the network entity. The uplink message transmitter 1140 is capable of, configured to, or operable to support a means for transmitting, to the network entity, the uplink message using the uplink beam of the UE based on the beam prediction procedure.

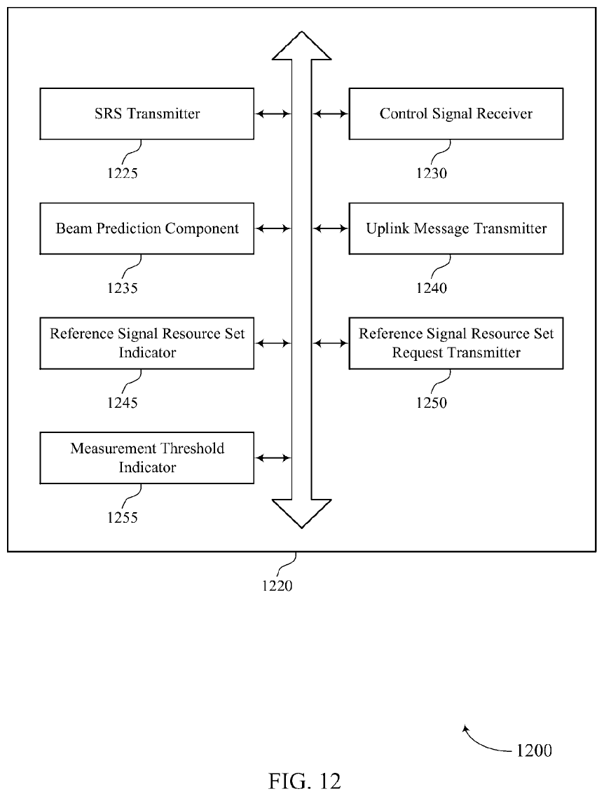

FIG. 12 shows a block diagram 1200 of a communications manager 1220 that supports reference signal quality indication for uplink beam prediction in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of reference signal quality indication for uplink beam prediction as described herein. For example, the communications manager 1220 may include an SRS transmitter 1225, a control signal receiver 1230, a beam prediction component 1235, an uplink message transmitter 1240, a reference signal resource set indicator 1245, a reference signal resource set request transmitter 1250, a measurement threshold indicator 1255, or any combination thereof. Each of these components may communicate, directly or indirectly, with one another (e.g., via one or more buses).

The communications manager 1220 may support wireless communication at a UE in accordance with examples as disclosed herein. The SRS transmitter 1225 is capable of, configured to, or operable to support a means for transmitting, to a network entity and using a set of multiple beams of the UE, a set of multiple SRSs via a set of multiple reference signal resource sets. The control signal receiver 1230 is capable of, configured to, or operable to support a means for receiving, from the network entity, a control signal indicating one or more reference signal measurements corresponding to one or more reference signal resource sets of the set of multiple reference signal resource sets based on the set of multiple SRSs. The beam prediction component 1235 is capable of, configured to, or operable to support a means for performing, based on the one or more reference signal measurements corresponding to the one or more reference signal resource sets, a beam prediction procedure to obtain an uplink beam of the UE for transmission of an uplink message to the network entity. The uplink message transmitter 1240 is capable of, configured to, or operable to support a means for transmitting, to the network entity, the uplink message using the uplink beam of the UE based on the beam prediction procedure.

In some examples, to support receiving the control signal, the control signal receiver 1230 is capable of, configured to, or operable to support a means for receiving the control signal including respective reference signal resource identifiers corresponding to the one or more reference signal measurements, the respective reference signal resource identifiers associated with at least one reference signal resource set of the set of multiple reference signal resource sets.

In some examples, to support receiving the control signal, the control signal receiver 1230 is capable of, configured to, or operable to support a means for receiving the control signal indicating a reference signal measurement of a SRS associated with a reference signal transmission occasion, the reference signal transmission occasion being a last reference signal transmission occasion before a set of time resources allocated for the control signal, where the one or more reference signal measurements includes the reference signal measurement.

In some examples, to support receiving the control signal, the control signal receiver 1230 is capable of, configured to, or operable to support a means for receiving the control signal indicating a reference signal measurement of a SRS according to a time domain offset, the time domain offset indicating a time duration between transmission of the set of multiple SRSs and a set of time resources allocated for the control signal, where the one or more reference signal measurements includes the reference signal measurement, and where the set of multiple SRSs includes the SRS.

In some examples, to support receiving the control signal, the control signal receiver 1230 is capable of, configured to, or operable to support a means for receiving the control signal indicating that the one or more reference signal measurements corresponds to two or more reference signal resource sets of the set of multiple reference signal resource sets, the two or more reference signal resource sets being within a time window associated with a filtering scheme associated with the one or more reference signal measurements.

In some examples, the reference signal resource set indicator 1245 is capable of, configured to, or operable to support a means for receiving, from the network entity, a second control signal indicating that measurements for at least one of the one or more reference signal resource sets is to be included in the control signal.

In some examples, the reference signal resource set request transmitter 1250 is capable of, configured to, or operable to support a means for transmitting, to the network entity, a request for the network entity to include measurements for at least one of the one or more reference signal resource sets in the control signal.

In some examples, to support receiving the control signal, the control signal receiver 1230 is capable of, configured to, or operable to support a means for receiving, in the control signal, a first set of bits indicating a first measurement of a first reference signal resource set of the set of multiple reference signal resource sets, and a second set of bits indicating a differential measurement relative to the first measurement, where the differential measurement relative to the first measurement indicates a quantized differential between the first measurement and the second measurement, and where a quantity of the first set of bits is greater than a quantity of the second set of bits.

In some examples, to support receiving the control signal, the control signal receiver 1230 is capable of, configured to, or operable to support a means for receiving, from the network entity, a SRS resource indicator indicating the one or more reference signal resource sets according to an order that is based on the one or more reference signal measurements.

In some examples, the measurement threshold indicator 1255 is capable of, configured to, or operable to support a means for communicating an indication of a measurement threshold with the network entity, where the one or more reference signal measurements satisfy the measurement threshold.

In some examples, the one or more reference signal measurements correspond to a first reference signal resource set associated with a first periodicity. In some examples, the uplink beam is obtained for transmission of the uplink message via a second reference signal resource set different from the first reference signal resource set, where the uplink message includes a SRS different from the set of multiple SRSs.

In some examples, to support performing the beam prediction procedure, the beam prediction component 1235 is capable of, configured to, or operable to support a means for receiving, from the network entity, a control signal indicating one or more reference signal measurements corresponding to a first reference signal resource set of the set of multiple reference signal resource sets. In some examples, to support performing the beam prediction procedure, the beam prediction component 1235 is capable of, configured to, or operable to support a means for performing, based on the one or more reference signal measurements corresponding to the first reference signal resource set, the beam prediction procedure to predict an uplink beam of the UE for subsequent communications using the first reference signal resource set.

In some examples, the set of multiple SRSs are transmitted according to a first transmission configuration indicator state, and the control signal receiver 1230 is capable of, configured to, or operable to support a means for receiving, from the network entity, a second control signal indicating a switch from the first transmission configuration indicator state to a second transmission indicator state for the uplink message, where the uplink message is transmitted based on the second transmission indicator state.

In some examples, to support receiving the control signal, the control signal receiver 1230 is capable of, configured to, or operable to support a means for receiving a medium access control channel element message, a radio resource control message, an uplink grant downlink control information message, or a downlink grant that indicates the one or more reference signal measurements.

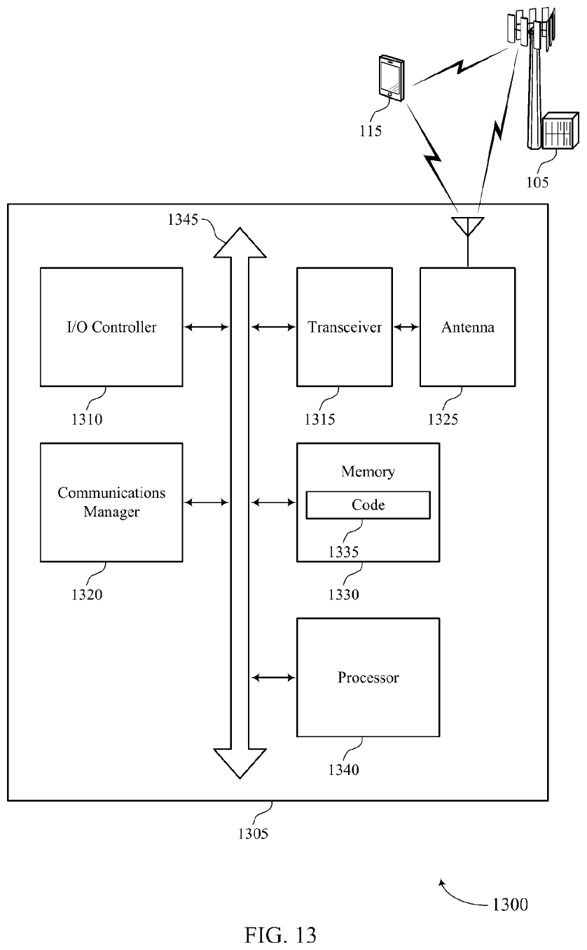

FIG. 13 shows a diagram of a system 1300 including a device 1305 that supports reference signal quality indication for uplink beam prediction in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting reference signal quality indication for uplink beam prediction). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a UE in accordance with examples as disclosed herein. For example, the communications manager 1320 is capable of, configured to, or operable to support a means for transmitting, to a network entity and using a set of multiple beams of the UE, a set of multiple SRSs via a set of multiple reference signal resource sets. The communications manager 1320 is capable of, configured to, or operable to support a means for receiving, from the network entity, a control signal indicating one or more reference signal measurements corresponding to one or more reference signal resource sets of the set of multiple reference signal resource sets based on the set of multiple SRSs. The communications manager 1320 is capable of, configured to, or operable to support a means for performing, based on the one or more reference signal measurements corresponding to the one or more reference signal resource sets, a beam prediction procedure to obtain an uplink beam of the UE for transmission of an uplink message to the network entity. The communications manager 1320 is capable of, configured to, or operable to support a means for transmitting, to the network entity, the uplink message using the uplink beam of the UE based on the beam prediction procedure.

By including or configuring the communications manager 1320 in accordance with examples as described herein, the device 1305 may support techniques for using reference signal measurements for a beam prediction procedure for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of reference signal quality indication for uplink beam prediction as described herein, or the processor 1340 and the memory 1330 may be otherwise configured to perform or support such operations.

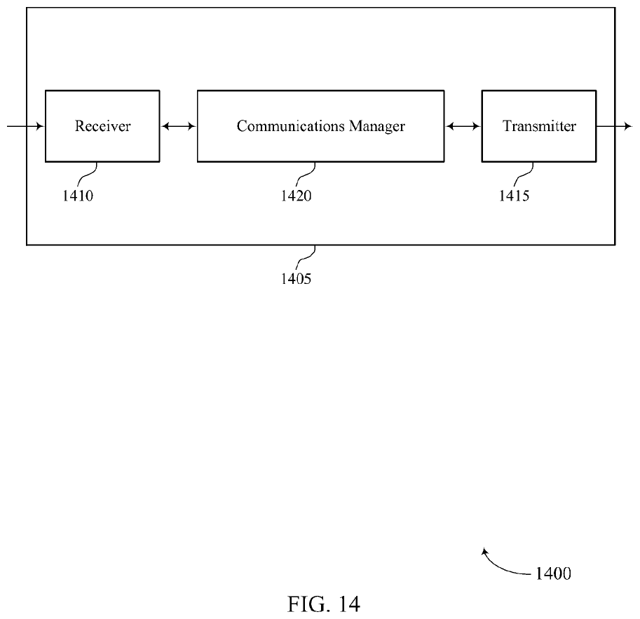

FIG. 14 shows a block diagram 1400 of a device 1405 that supports reference signal quality indication for uplink beam prediction in accordance with one or more aspects of the present disclosure. The device 1405 may be an example of aspects of a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of reference signal quality indication for uplink beam prediction as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples as disclosed herein. For example, the communications manager 1420 is capable of, configured to, or operable to support a means for receiving, from a UE via a set of multiple beams of the UE, a set of multiple SRSs via a set of multiple reference signal resource sets. The communications manager 1420 is capable of, configured to, or operable to support a means for transmitting, to the UE, a control signal indicating one or more reference signal measurements corresponding to one or more reference signal resource sets of the set of multiple reference signal resource sets based on the set of multiple SRSs. The communications manager 1420 is capable of, configured to, or operable to support a means for receiving, from the UE, an uplink message using an uplink beam of the UE.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for using reference signal measurements for a beam prediction procedure for reduced processing, reduced power consumption, and more efficient utilization of communication resources.

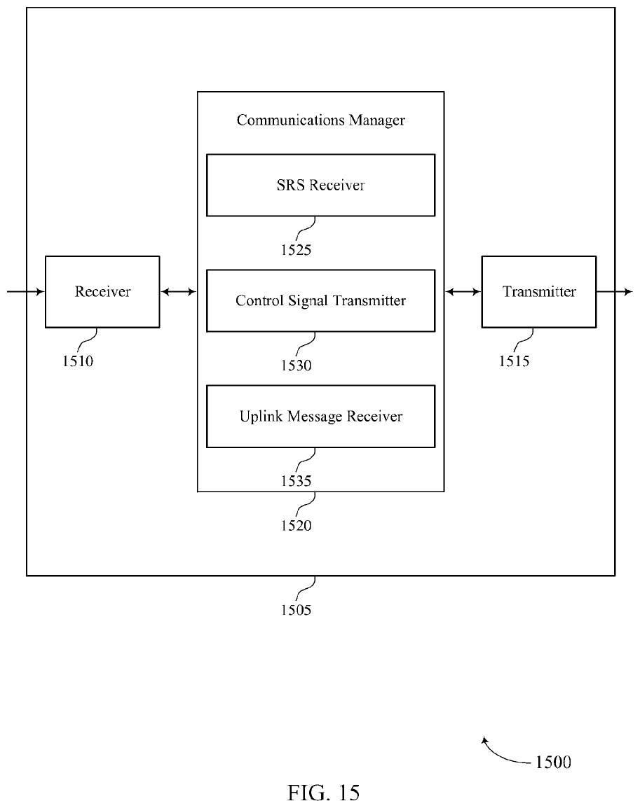

FIG. 15 shows a block diagram 1500 of a device 1505 that supports reference signal quality indication for uplink beam prediction in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of reference signal quality indication for uplink beam prediction as described herein. For example, the communications manager 1520 may include an SRS receiver 1525, a control signal transmitter 1530, an uplink message receiver 1535, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication at a network entity in accordance with examples as disclosed herein. The SRS receiver 1525 is capable of, configured to, or operable to support a means for receiving, from a UE via a set of multiple beams of the UE, a set of multiple SRSs via a set of multiple reference signal resource sets. The control signal transmitter 1530 is capable of, configured to, or operable to support a means for transmitting, to the UE, a control signal indicating one or more reference signal measurements corresponding to one or more reference signal resource sets of the set of multiple reference signal resource sets based on the set of multiple SRSs. The uplink message receiver 1535 is capable of, configured to, or operable to support a means for receiving, from the UE, an uplink message using an uplink beam of the UE.

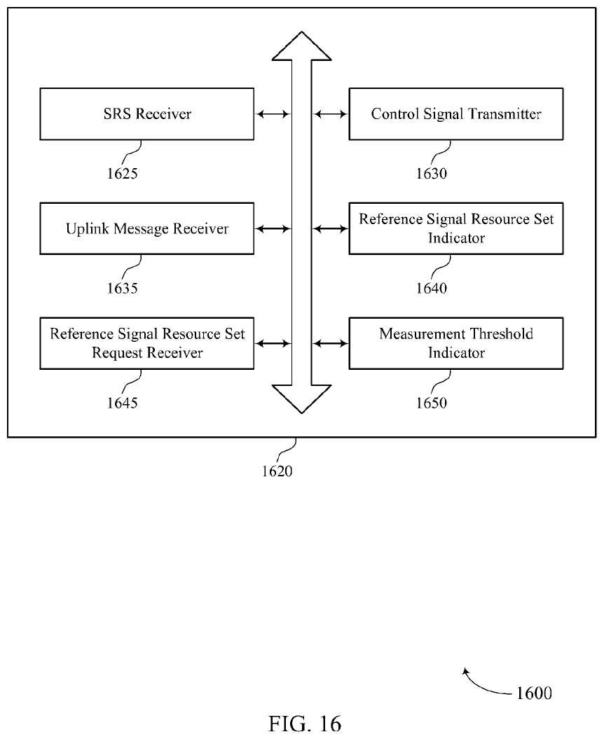

FIG. 16 shows a block diagram 1600 of a communications manager 1620 that supports reference signal quality indication for uplink beam prediction in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of reference signal quality indication for uplink beam prediction as described herein. For example, the communications manager 1620 may include an SRS receiver 1625, a control signal transmitter 1630, an uplink message receiver 1635, a reference signal resource set indicator 1640, a reference signal resource set request receiver 1645, a measurement threshold indicator 1650, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communication at a network entity in accordance with examples as disclosed herein. The SRS receiver 1625 is capable of, configured to, or operable to support a means for receiving, from a UE via a set of multiple beams of the UE, a set of multiple SRSs via a set of multiple reference signal resource sets. The control signal transmitter 1630 is capable of, configured to, or operable to support a means for transmitting, to the UE, a control signal indicating one or more reference signal measurements corresponding to one or more reference signal resource sets of the set of multiple reference signal resource sets based on the set of multiple SRSs. The uplink message receiver 1635 is capable of, configured to, or operable to support a means for receiving, from the UE, an uplink message using an uplink beam of the UE.

In some examples, to support transmitting the control signal, the uplink message receiver 1635 is capable of, configured to, or operable to support a means for transmitting the control signal including respective reference signal resource identifiers corresponding to the one or more reference signal measurements, the respective reference signal resource identifiers associated with at least one reference signal resource set of the set of multiple reference signal resource sets.

In some examples, to support transmitting the control signal, the uplink message receiver 1635 is capable of, configured to, or operable to support a means for transmitting the control signal indicating a reference signal measurement of a SRS associated with a reference signal transmission occasion, the reference signal transmission occasion being a last reference signal transmission occasion before a set of time resources allocated for the control signal, where the one or more reference signal measurements includes the reference signal measurement.

In some examples, to support transmitting the control signal, the uplink message receiver 1635 is capable of, configured to, or operable to support a means for transmitting the control signal indicating a reference signal measurement of a SRS according to a time domain offset, the time domain offset indicating a time duration between transmission of the set of multiple SRSs and a set of time resources allocated for the control signal, where the one or more reference signal measurements includes the reference signal measurement, and where the set of multiple SRSs includes the SRS.

In some examples, to support transmitting the control signal, the uplink message receiver 1635 is capable of, configured to, or operable to support a means for transmitting the control signal indicating that the one or more reference signal measurements corresponds to two or more reference signal resource sets of the set of multiple reference signal resource sets, the two or more reference signal resource sets being within a time window associated with a filtering scheme associated with the one or more reference signal measurements.

In some examples, the reference signal resource set indicator 1640 is capable of, configured to, or operable to support a means for transmitting, to the UE, a second control signal indicating that measurements for at least one of the one or more reference signal resource sets is to be included in the control signal.

In some examples, the reference signal resource set request receiver 1645 is capable of, configured to, or operable to support a means for receiving, from the UE, a request for the network entity to include measurements for at least one of the one or more reference signal resource sets in the control signal.

In some examples, to support transmitting the control signal, the control signal transmitter 1630 is capable of, configured to, or operable to support a means for transmitting, in the control signal, a first set of bits indicating a first measurement of a first reference signal resource set of the set of multiple reference signal resource sets, and a second set of bits indicating a differential measurement relative to the first measurement, where the differential measurement relative to the first measurement indicates a quantized differential between the first measurement and the second measurement, and where a quantity of the first set of bits is greater than a quantity of the second set of bits.

In some examples, to support transmitting the control signal, the control signal transmitter 1630 is capable of, configured to, or operable to support a means for transmitting, to the UE, a SRS resource indicator indicating the one or more reference signal resource sets according to an order that is based on the one or more reference signal measurements.

In some examples, the measurement threshold indicator 1650 is capable of, configured to, or operable to support a means for communicating an indication of a measurement threshold with the UE, where the one or more reference signal measurements satisfy the measurement threshold.

In some examples, the one or more reference signal measurements correspond to a first reference signal resource set associated with a first periodicity.

In some examples, the set of multiple SRSs are received according to a first transmission configuration indicator state, and the control signal transmitter 1630 is capable of, configured to, or operable to support a means for transmitting, to the UE, a second control signal indicating a switch from the first transmission configuration indicator state to a second transmission indicator state for the uplink message, where the uplink message is transmitted based on the second transmission indicator state.

In some examples, to support transmitting the control signal, the control signal transmitter 1630 is capable of, configured to, or operable to support a means for transmitting a medium access control channel element message, a radio resource control message, an uplink grant downlink control information message, or a downlink grant that indicates the one or more reference signal measurements.

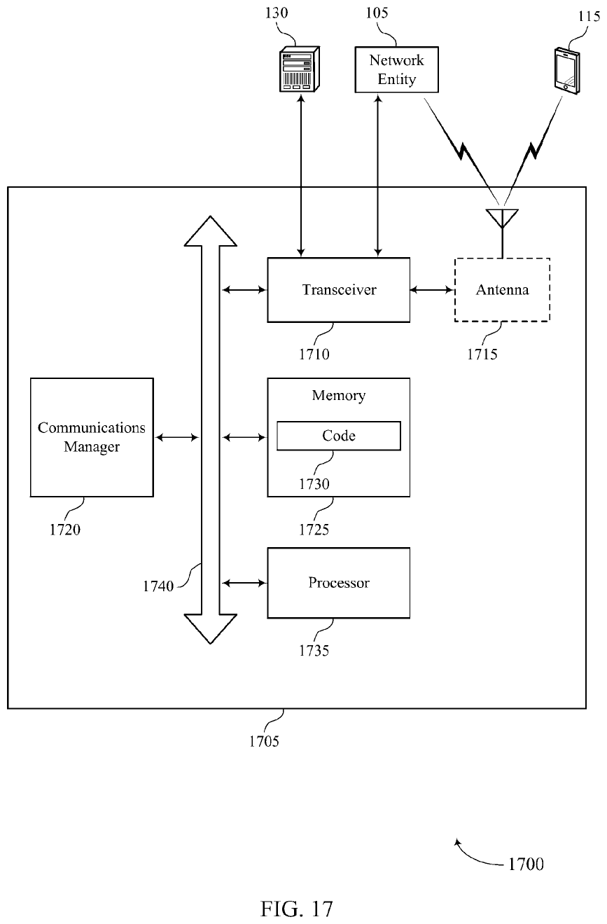

FIG. 17 shows a diagram of a system 1700 including a device 1705 that supports reference signal quality indication for uplink beam prediction in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, a memory 1725, code 1730, and a processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or memory components (for example, the processor 1735, or the memory 1725, or both), may be included in a chip or chip assembly that is installed in the device 1705. In some examples, the transceiver may be operable to support communications via one or more communications links (e.g., a communication link 125, a backhaul communication link 120, a midhaul communication link 162, a fronthaul communication link 168).

The memory 1725 may include RAM and ROM. The memory 1725 may store computer-readable, computer-executable code 1730 including instructions that, when executed by the processor 1735, cause the device 1705 to perform various functions described herein. The code 1730 may be stored in a non-transitory computer-readable medium such as system memory or another type of memory. In some cases, the code 1730 may not be directly executable by the processor 1735 but may cause a computer (e.g., when compiled and executed) to perform functions described herein. In some cases, the memory 1725 may contain, among other things, a BIOS which may control basic hardware or software operation such as the interaction with peripheral components or devices.

The processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1735 may be configured to operate a memory array using a memory controller. In some other cases, a memory controller may be integrated into the processor 1735. The processor 1735 may be configured to execute computer-readable instructions stored in a memory (e.g., the memory 1725) to cause the device 1705 to perform various functions (e.g., functions or tasks supporting reference signal quality indication for uplink beam prediction). For example, the device 1705 or a component of the device 1705 may include a processor 1735 and memory 1725 coupled with the processor 1735, the processor 1735 and memory 1725 configured to perform various functions described herein. The processor 1735 may be an example of a cloud-computing platform (e.g., one or more physical nodes and supporting software such as operating systems, virtual machines, or container instances) that may host the functions (e.g., by executing code 1730) to perform the functions of the device 1705. The processor 1735 may be any one or more suitable processors capable of executing scripts or instructions of one or more software programs stored in the device 1705 (such as within the memory 1725). In some implementations, the processor 1735 may be a component of a processing system. A processing system may generally refer to a system or series of machines or components that receives inputs and processes the inputs to produce a set of outputs (which may be passed to other systems or components of, for example, the device 1705). For example, a processing system of the device 1705 may refer to a system including the various other components or subcomponents of the device 1705, such as the processor 1735, or the transceiver 1710, or the communications manager 1720, or other components or combinations of components of the device 1705. The processing system of the device 1705 may interface with other components of the device 1705, and may process information received from other components (such as inputs or signals) or output information to other components. For example, a chip or modem of the device 1705 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1705 may transmit information output from the chip or modem. Additionally, or alternatively, in some implementations, the one or more interfaces may refer to an interface between the processing system of the chip or modem and a receiver, such that the device 1705 may obtain information or signal inputs, and the information may be passed to the processing system. A person having ordinary skill in the art will readily recognize that a first interface also may obtain information or signal inputs, and a second interface also may output information or signal outputs.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the memory 1725, the code 1730, and the processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communication at a network entity in accordance with examples as disclosed herein. For example, the communications manager 1720 is capable of, configured to, or operable to support a means for receiving, from a UE via a set of multiple beams of the UE, a set of multiple SRSs via a set of multiple reference signal resource sets. The communications manager 1720 is capable of, configured to, or operable to support a means for transmitting, to the UE, a control signal indicating one or more reference signal measurements corresponding to one or more reference signal resource sets of the set of multiple reference signal resource sets based on the set of multiple SRSs. The communications manager 1720 is capable of, configured to, or operable to support a means for receiving, from the UE, an uplink message using an uplink beam of the UE.

By including or configuring the communications manager 1720 in accordance with examples as described herein, the device 1705 may support techniques for using reference signal measurements for a beam prediction procedure for improved communication reliability, reduced latency, improved user experience related to reduced processing, reduced power consumption, more efficient utilization of communication resources, improved coordination between devices, longer battery life, and improved utilization of processing capability.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, the processor 1735, the memory 1725, the code 1730, or any combination thereof. For example, the code 1730 may include instructions executable by the processor 1735 to cause the device 1705 to perform various aspects of reference signal quality indication for uplink beam prediction as described herein, or the processor 1735 and the memory 1725 may be otherwise configured to perform or support such operations.

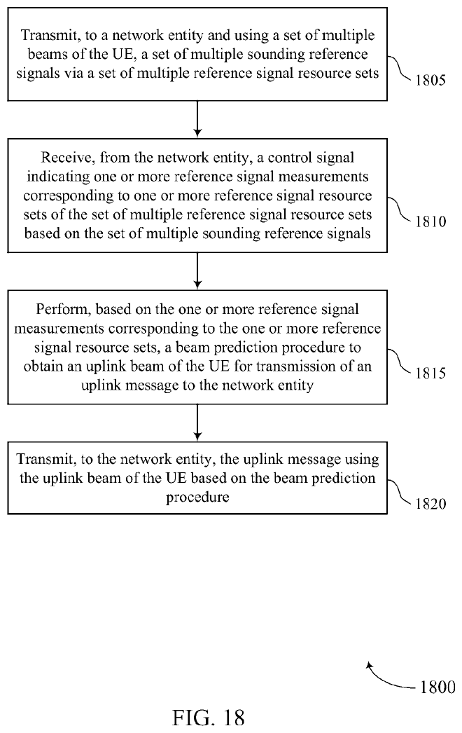

FIG. 18 shows a flowchart illustrating a method 1800 that supports reference signal quality indication for uplink beam prediction in accordance with aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include transmitting, to a network entity and using a set of multiple beams of the UE, a set of multiple SRSs via a set of multiple reference signal resource sets. The operations of block 1805 may be performed in accordance with examples as disclosed herein. In some examples, aspects of the operations of 1805 may be performed by an SRS transmitter 1225 as described with reference to FIG. 12.

At 1810, the method may include receiving, from the network entity, a control signal indicating one or more reference signal measurements corresponding to one or more reference signal resource sets of the set of multiple reference signal resource sets based on the set of multiple SRSs. The operations of block 1810 may be performed in accordance with examples as disclosed herein. In some examples, aspects of the operations of 1810 may be performed by a control signal receiver 1230 as described with reference to FIG. 12.

At 1815, the method may include performing, based on the one or more reference signal measurements corresponding to the one or more reference signal resource sets, a beam prediction procedure to obtain an uplink beam of the UE for transmission of an uplink message to the network entity. The operations of block 1815 may be performed in accordance with examples as disclosed herein. In some examples, aspects of the operations of 1815 may be performed by a beam prediction component 1235 as described with reference to FIG. 12.

At 1820, the method may include transmitting, to the network entity, the uplink message using the uplink beam of the UE based on the beam prediction procedure. The operations of block 1820 may be performed in accordance with examples as disclosed herein. In some examples, aspects of the operations of 1820 may be performed by an uplink message transmitter 1240 as described with reference to FIG. 12.

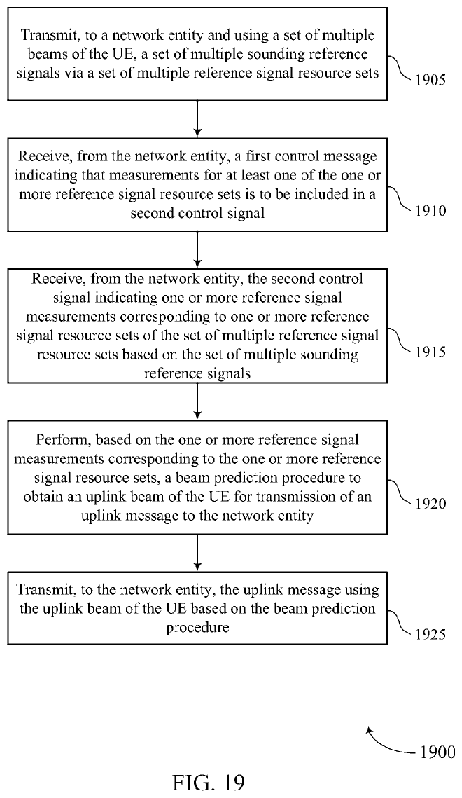

FIG. 19 shows a flowchart illustrating a method 1900 that supports reference signal quality indication for uplink beam prediction in accordance with aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include transmitting, to a network entity and using a set of multiple beams of the UE, a set of multiple SRSs via a set of multiple reference signal resource sets. The operations of block 1905 may be performed in accordance with examples as disclosed herein. In some examples, aspects of the operations of 1905 may be performed by an SRS transmitter 1225 as described with reference to FIG. 12.

At 1910, the method may include receiving, from the network entity, a first control signal indicating that measurements for at least one of the one or more reference signal resource sets is to be included in a second control signal. The operations of block 1910 may be performed in accordance with examples as disclosed herein. In some examples, aspects of the operations of 1910 may be performed by a reference signal resource set indicator 1245 as described with reference to FIG. 12.

At 1915, the method may include receiving, from the network entity, the second control signal indicating one or more reference signal measurements corresponding to one or more reference signal resource sets of the set of multiple reference signal resource sets based on the set of multiple SRSs. The operations of block 1915 may be performed in accordance with examples as disclosed herein. In some examples, aspects of the operations of 1915 may be performed by a control signal receiver 1230 as described with reference to FIG. 12.

At 1920, the method may include performing, based on the one or more reference signal measurements corresponding to the one or more reference signal resource sets, a beam prediction procedure to obtain an uplink beam of the UE for transmission of an uplink message to the network entity. The operations of block 1920 may be performed in accordance with examples as disclosed herein. In some examples, aspects of the operations of 1920 may be performed by a beam prediction component 1235 as described with reference to FIG. 12.

At 1925, the method may include transmitting, to the network entity, the uplink message using the uplink beam of the UE based on the beam prediction procedure. The operations of block 1925 may be performed in accordance with examples as disclosed herein. In some examples, aspects of the operations of 1925 may be performed by an uplink message transmitter 1240 as described with reference to FIG. 12.

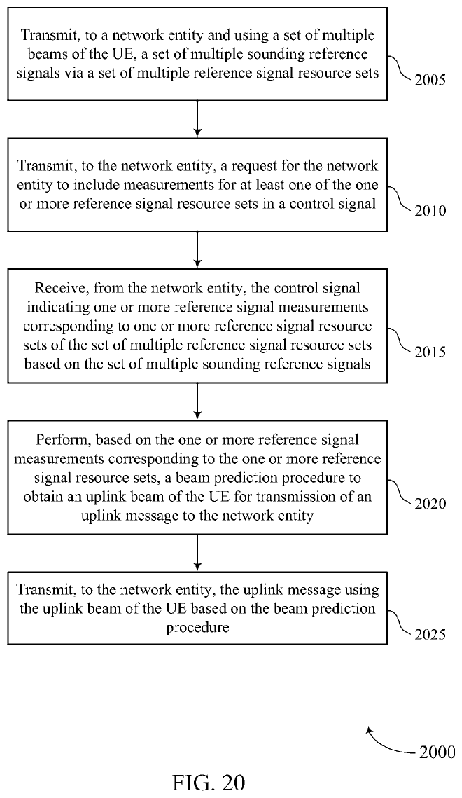

FIG. 20 shows a flowchart illustrating a method 2000 that supports reference signal quality indication for uplink beam prediction in accordance with aspects of the present disclosure. The operations of the method 2000 may be implemented by a UE or its components as described herein. For example, the operations of the method 2000 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 2005, the method may include transmitting, to a network entity and using a set of multiple beams of the UE, a set of multiple SRSs via a set of multiple reference signal resource sets. The operations of block 2005 may be performed in accordance with examples as disclosed herein. In some examples, aspects of the operations of 2005 may be performed by an SRS transmitter 1225 as described with reference to FIG. 12.

At 2010, the method may include transmitting, to the network entity, a request for the network entity to include measurements for at least one of the one or more reference signal resource sets in a control signal. The operations of block 2010 may be performed in accordance with examples as disclosed herein. In some examples, aspects of the operations of 2010 may be performed by a reference signal resource set request transmitter 1250 as described with reference to FIG. 12.

At 2015, the method may include receiving, from the network entity, the control signal indicating one or more reference signal measurements corresponding to one or more reference signal resource sets of the set of multiple reference signal resource sets based on the set of multiple SRSs. The operations of block 2015 may be performed in accordance with examples as disclosed herein. In some examples, aspects of the operations of 2015 may be performed by a control signal receiver 1230 as described with reference to FIG. 12.

At 2020, the method may include performing, based on the one or more reference signal measurements corresponding to the one or more reference signal resource sets, a beam prediction procedure to obtain an uplink beam of the UE for transmission of an uplink message to the network entity. The operations of block 2020 may be performed in accordance with examples as disclosed herein. In some examples, aspects of the operations of 2020 may be performed by a beam prediction component 1235 as described with reference to FIG. 12.

At 2025, the method may include transmitting, to the network entity, the uplink message using the uplink beam of the UE based on the beam prediction procedure. The operations of block 2025 may be performed in accordance with examples as disclosed herein. In some examples, aspects of the operations of 2025 may be performed by an uplink message transmitter 1240 as described with reference to FIG. 12.

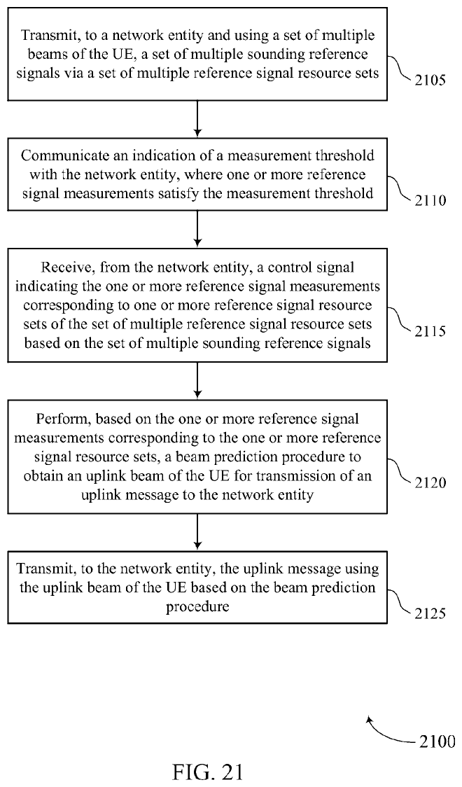

FIG. 21 shows a flowchart illustrating a method 2100 that supports reference signal quality indication for uplink beam prediction in accordance with aspects of the present disclosure. The operations of the method 2100 may be implemented by a UE or its components as described herein. For example, the operations of the method 2100 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 2105, the method may include transmitting, to a network entity and using a set of multiple beams of the UE, a set of multiple SRSs via a set of multiple reference signal resource sets. The operations of block 2105 may be performed in accordance with examples as disclosed herein. In some examples, aspects of the operations of 2105 may be performed by an SRS transmitter 1225 as described with reference to FIG. 12.

At 2110, the method may include communicating an indication of a measurement threshold with the network entity, where one or more reference signal measurements satisfy the measurement threshold. The operations of block 2110 may be performed in accordance with examples as disclosed herein. In some examples, aspects of the operations of 2110 may be performed by a measurement threshold indicator 1255 as described with reference to FIG. 12.

At 2115, the method may include receiving, from the network entity, a control signal indicating the one or more reference signal measurements corresponding to one or more reference signal resource sets of the set of multiple reference signal resource sets based on the set of multiple SRSs. The operations of block 2115 may be performed in accordance with examples as disclosed herein. In some examples, aspects of the operations of 2115 may be performed by a control signal receiver 1230 as described with reference to FIG. 12.

At 2120, the method may include performing, based on the one or more reference signal measurements corresponding to the one or more reference signal resource sets, a beam prediction procedure to obtain an uplink beam of the UE for transmission of an uplink message to the network entity. The operations of block 2120 may be performed in accordance with examples as disclosed herein. In some examples, aspects of the operations of 2120 may be performed by a beam prediction component 1235 as described with reference to FIG. 12.

At 2125, the method may include transmitting, to the network entity, the uplink message using the uplink beam of the UE based on the beam prediction procedure. The operations of block 2125 may be performed in accordance with examples as disclosed herein. In some examples, aspects of the operations of 2125 may be performed by an uplink message transmitter 1240 as described with reference to FIG. 12.

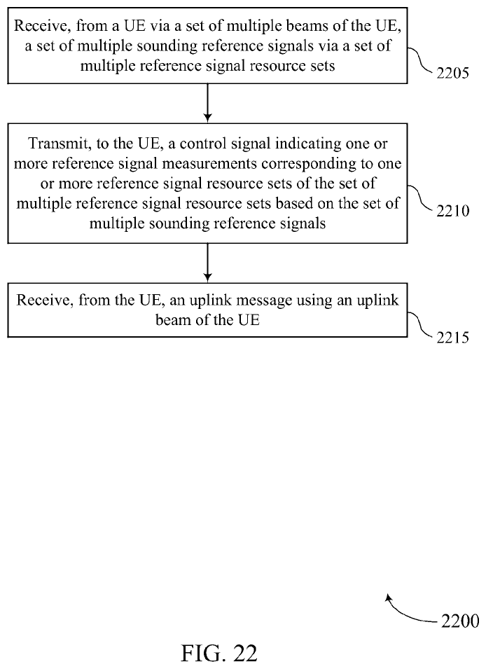

FIG. 22 shows a flowchart illustrating a method 2200 that supports reference signal quality indication for uplink beam prediction in accordance with aspects of the present disclosure. The operations of the method 2200 may be implemented by a network entity or its components as described herein. For example, the operations of the method 2200 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2205, the method may include receiving, from a UE via a set of multiple beams of the UE, a set of multiple SRSs via a set of multiple reference signal resource sets. The operations of block 2205 may be performed in accordance with examples as disclosed herein. In some examples, aspects of the operations of 2205 may be performed by an SRS receiver 1625 as described with reference to FIG. 16.

At 2210, the method may include transmitting, to the UE, a control signal indicating one or more reference signal measurements corresponding to one or more reference signal resource sets of the set of multiple reference signal resource sets based on the set of multiple SRSs. The operations of block 2210 may be performed in accordance with examples as disclosed herein. In some examples, aspects of the operations of 2210 may be performed by a control signal transmitter 1630 as described with reference to FIG. 16.

At 2215, the method may include receiving, from the UE, an uplink message using an uplink beam of the UE. The operations of block 2215 may be performed in accordance with examples as disclosed herein. In some examples, aspects of the operations of 2215 may be performed by an uplink message receiver 1635 as described with reference to FIG. 16.

The following provides an overview of aspects of the present disclosure:
Aspect 1: A method for wireless communication at a UE, comprising: transmitting, to a network entity and using a plurality of beams of the UE, a plurality of SRSs via a plurality of reference signal resource sets; receiving, from the network entity, a control signal indicating one or more reference signal measurements corresponding to one or more reference signal resource sets of the plurality of reference signal resource sets based at least in part on the plurality of SRSs; performing, based at least in part on the one or more reference signal measurements corresponding to the one or more reference signal resource sets, a beam prediction procedure to obtain an uplink beam of the UE for transmission of an uplink message to the network entity; and transmitting, to the network entity, the uplink message using the uplink beam of the UE based at least in part on the beam prediction procedure.
Aspect 2: The method of aspect 1, wherein receiving the control signal comprises: receiving the control signal comprising respective reference signal resource IDs corresponding to the one or more reference signal measurements, the respective reference signal resource IDs associated with at least one reference signal resource set of the plurality of reference signal resource sets.
Aspect 3: The method of any of aspects 1 through 2, wherein receiving the control signal comprises: receiving the control signal indicating a reference signal measurement of a SRS associated with a reference signal transmission occasion, the reference signal transmission occasion being a last reference signal transmission occasion before a set of time resources allocated for the control signal, wherein the one or more reference signal measurements includes the reference signal measurement.
Aspect 4: The method of any of aspects 1 through 3, wherein receiving the control signal comprises: receiving the control signal indicating a reference signal measurement of a SRS according to a time domain offset, the time domain offset indicating a time duration between the transmission of the plurality of SRSs and a set of time resources allocated for the control signal, wherein the one or more reference signal measurements includes the reference signal measurement, and wherein the plurality of SRSs includes the SRS.
Aspect 5: The method of any of aspects 1 through 4, wherein receiving the control signal comprises: receiving the control signal indicating that the one or more reference signal measurements corresponds to two or more reference signal resource sets of the plurality of reference signal resource sets, the two or more reference signal resource sets being within a time window associated with a filtering scheme associated with the one or more reference signal measurements.
Aspect 6: The method of any of aspects 1 through 5, further comprising: receiving, from the network entity, a second control signal indicating that measurements for at least one of the one or more reference signal resource sets is to be included in the control signal.
Aspect 7: The method of any of aspects 1 through 6, further comprising: transmitting, to the network entity, a request for the network entity to include measurements for at least one of the one or more reference signal resource sets in the control signal.
Aspect 8: The method of any of aspects 1 through 7, wherein receiving the control signal comprises: receiving, in the control signal, a first set of bits indicating a first measurement of a first reference signal resource set of the plurality of reference signal resource sets, and a second set of bits indicating a differential measurement relative to the first measurement, wherein the differential measurement relative to the first measurement indicates a quantized differential between the first measurement and a second measurement, and wherein a quantity of the first set of bits is greater than a quantity of the second set of bits.
Aspect 9: The method of any of aspects 1 through 8, wherein receiving the control signal comprises: receiving, from the network entity, a SRI indicating the one or more reference signal resource sets according to an order that is based at least in part on the one or more reference signal measurements.
Aspect 10: The method of any of aspects 1 through 9, further comprising: communicating an indication of a measurement threshold with the network entity, wherein the one or more reference signal measurements satisfy the measurement threshold.
Aspect 11: The method of any of aspects 1 through 10, wherein the one or more reference signal measurements correspond to a first reference signal resource set associated with a first periodicity; and the uplink beam is obtained for the transmission of the uplink message via a second reference signal resource set different from the first reference signal resource set, wherein the uplink message comprises a SRS different from the plurality of SRSs.
Aspect 12: The method of any of aspects 1 through 11, wherein performing the beam prediction procedure comprises: receiving, from the network entity, the control signal indicating the one or more reference signal measurements corresponding to a first reference signal resource set of the plurality of reference signal resource sets; and performing, based at least in part on the one or more reference signal measurements corresponding to the first reference signal resource set, the beam prediction procedure to predict the uplink beam of the UE for subsequent communications using the first reference signal resource set.
Aspect 13: The method of any of aspects 1 through 12, wherein the plurality of SRSs are transmitted according to a first transmission configuration indicator state, the method further comprising: receiving, from the network entity, a second control signal indicating a switch from the first transmission configuration indicator state to a second transmission indicator state for the uplink message, wherein the uplink message is transmitted based at least in part on the second transmission indicator state.
Aspect 14: The method of any of aspects 1 through 13, wherein receiving the control signal comprises: receiving a MAC-CE, an RRC message, an uplink grant DCI message, or a downlink grant that indicates the one or more reference signal measurements.
Aspect 15: A method for wireless communication at a network entity, comprising: receiving, from a UE via a plurality of beams of the UE, a plurality of SRSs via a plurality of reference signal resource sets; transmitting, to the UE, a control signal indicating one or more reference signal measurements corresponding to one or more reference signal resource sets of the plurality of reference signal resource sets based at least in part on the plurality of SRSs; and receiving, from the UE, an uplink message using an uplink beam of the UE.
Aspect 16: The method of aspect 15, wherein transmitting the control signal comprises: transmitting the control signal comprising respective reference signal resource IDs corresponding to the one or more reference signal measurements, the respective reference signal resource IDs associated with at least one reference signal resource set of the plurality of reference signal resource sets.
Aspect 17: The method of any of aspects 15 through 16, wherein transmitting the control signal comprises: transmitting the control signal indicating a reference signal measurement of a SRS associated with a reference signal transmission occasion, the reference signal transmission occasion being a last reference signal transmission occasion before a set of time resources allocated for the control signal, wherein the one or more reference signal measurements includes the reference signal measurement.
Aspect 18: The method of any of aspects 15 through 17, wherein transmitting the control signal comprises: transmitting the control signal indicating a reference signal measurement of a SRS according to a time domain offset, the time domain offset indicating a time duration between transmission of the plurality of SRSs and a set of time resources allocated for the control signal, wherein the one or more reference signal measurements includes the reference signal measurement, and wherein the plurality of SRSs includes the SRS.
Aspect 19: The method of any of aspects 15 through 18, wherein transmitting the control signal comprises: transmitting the control signal indicating that the one or more reference signal measurements corresponds to two or more reference signal resource sets of the plurality of reference signal resource sets, the two or more reference signal resource sets being within a time window associated with a filtering scheme associated with the one or more reference signal measurements.
Aspect 20: The method of any of aspects 15 through 19, further comprising: transmitting, to the UE, a second control signal indicating that measurements for at least one of the one or more reference signal resource sets is to be included in the control signal.
Aspect 21: The method of any of aspects 15 through 20, further comprising: receiving, from the UE, a request for the network entity to include measurements for at least one of the one or more reference signal resource sets in the control signal.
Aspect 22: The method of any of aspects 15 through 21, wherein transmitting the control signal comprises: transmitting, in the control signal, a first set of bits indicating a first measurement of a first reference signal resource set of the plurality of reference signal resource sets, and a second set of bits indicating a differential measurement relative to the first measurement, wherein the differential measurement relative to the first measurement indicates a quantized differential between the first measurement and a second measurement, and wherein a quantity of the first set of bits is greater than a quantity of the second set of bits.
Aspect 23: The method of any of aspects 15 through 22, wherein transmitting the control signal comprises: transmitting, to the UE, a SRI indicating the one or more reference signal resource sets according to an order that is based at least in part on the one or more reference signal measurements.
Aspect 24: The method of any of aspects 15 through 23, further comprising: communicating an indication of a measurement threshold with the UE, wherein the one or more reference signal measurements satisfy the measurement threshold.
Aspect 25: The method of any of aspects 15 through 24, wherein the one or more reference signal measurements correspond to a first reference signal resource set associated with a first periodicity.
Aspect 26: The method of any of aspects 15 through 25, wherein the plurality of SRSs are received according to a first transmission configuration indicator state, the method further comprising: transmitting, to the UE, a second control signal indicating a switch from the first transmission configuration indicator state to a second transmission indicator state for the uplink message, wherein the uplink message is transmitted based at least in part on the second transmission indicator state.
Aspect 27: The method of any of aspects 15 through 26, wherein transmitting the control signal comprises: transmitting a MAC-CE, an RRC message, an uplink grant DCI message, or a downlink grant that indicates the one or more reference signal measurements.
Aspect 28: An apparatus for wireless communication at a UE, comprising a processor; memory coupled with the processor; and instructions stored in the memory and executable by the processor to cause the apparatus to perform a method of any of aspects 1 through 14.
Aspect 29: An apparatus for wireless communication at a UE, comprising at least one means for performing a method of any of aspects 1 through 14.
Aspect 30: A non-transitory computer-readable medium storing code for wireless communication at a UE, the code comprising instructions executable by a processor to perform a method of any of aspects 1 through 14.
Aspect 31: An apparatus for wireless communication at a network entity, comprising a processor; memory coupled with the processor; and instructions stored in the memory and executable by the processor to cause the apparatus to perform a method of any of aspects 15 through 27.
Aspect 32: An apparatus for wireless communication at a network entity, comprising at least one means for performing a method of any of aspects 15 through 27.
Aspect 33: A non-transitory computer-readable medium storing code for wireless communication at a network entity, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
transmit, to a network entity and using a plurality of beams of the UE, a plurality of sounding reference signals via a plurality of reference signal resource sets;
receive, from the network entity, a control signal indicating one or more reference signal measurements corresponding to one or more reference signal resource sets of the plurality of reference signal resource sets based at least in part on the plurality of sounding reference signals;
perform, based at least in part on the one or more reference signal measurements corresponding to the one or more reference signal resource sets, a beam prediction procedure to obtain an uplink beam of the UE for transmission of an uplink message to the network entity; and
transmit, to the network entity, the uplink message using the uplink beam of the UE based at least in part on the beam prediction procedure.

2. The apparatus of claim 1, wherein the instructions to receive the control signal are executable by the processor to cause the apparatus to:
receive the control signal comprising respective reference signal resource identifiers corresponding to the one or more reference signal measurements, the respective reference signal resource identifiers associated with at least one reference signal resource set of the plurality of reference signal resource sets.

3. The apparatus of claim 1, wherein the instructions to receive the control signal are executable by the processor to cause the apparatus to:
receive the control signal indicating a reference signal measurement of a sounding reference signal associated with a reference signal transmission occasion, the reference signal transmission occasion being a last reference signal transmission occasion before a set of time resources allocated for the control signal, wherein the one or more reference signal measurements includes the reference signal measurement.

4. The apparatus of claim 1, wherein the instructions to receive the control signal are executable by the processor to cause the apparatus to:
receive the control signal indicating a reference signal measurement of a sounding reference signal according to a time domain offset, the time domain offset indicating a time duration between the transmission of the plurality of sounding reference signals and a set of time resources allocated for the control signal, wherein the one or more reference signal measurements includes the reference signal measurement, and wherein the plurality of sounding reference signals includes the sounding reference signal.

5. The apparatus of claim 1, wherein the instructions to receive the control signal are executable by the processor to cause the apparatus to:
receive the control signal indicating that the one or more reference signal measurements corresponds to two or more reference signal resource sets of the plurality of reference signal resource sets, the two or more reference signal resource sets being within a time window associated with a filtering scheme associated with the one or more reference signal measurements.

6. The apparatus of claim 1, wherein the instructions are further executable by the processor to cause the apparatus to:
receive, from the network entity, a second control signal indicating that measurements for at least one of the one or more reference signal resource sets is to be included in the control signal.

7. The apparatus of claim 1, wherein the instructions are further executable by the processor to cause the apparatus to:
transmit, to the network entity, a request for the network entity to include measurements for at least one of the one or more reference signal resource sets in the control signal.

8. The apparatus of claim 1, wherein the instructions to receive the control signal are executable by the processor to cause the apparatus to:
receive, in the control signal, a first set of bits indicating a first measurement of a first reference signal resource set of the plurality of reference signal resource sets, and a second set of bits indicating a differential measurement relative to the first measurement, wherein the differential measurement relative to the first measurement indicates a quantized differential between the first measurement and a second measurement, and wherein a quantity of the first set of bits is greater than a quantity of the second set of bits.

9. The apparatus of claim 1, wherein the instructions to receive the control signal are executable by the processor to cause the apparatus to:
receive, from the network entity, a sounding reference signal resource indicator indicating the one or more reference signal resource sets according to an order that is based at least in part on the one or more reference signal measurements.

10. The apparatus of claim 1, wherein the instructions are further executable by the processor to cause the apparatus to:
communicate an indication of a measurement threshold with the network entity, wherein the one or more reference signal measurements satisfy the measurement threshold.

11-14. (canceled)

15. An apparatus for wireless communication at a network entity, comprising:
a processor;
memory coupled with the processor; and
instructions stored in the memory and executable by the processor to cause the apparatus to:
receive, from a user equipment (UE) via a plurality of beams of the UE, a plurality of sounding reference signals via a plurality of reference signal resource sets;
transmit, to the UE, a control signal indicating one or more reference signal measurements corresponding to one or more reference signal resource sets of the plurality of reference signal resource sets based at least in part on the plurality of sounding reference signals; and
receive, from the UE, an uplink message using an uplink beam of the UE.

16. The apparatus of claim 15, wherein the instructions to transmit the control signal are executable by the processor to cause the apparatus to:
transmit the control signal comprising respective reference signal resource identifiers corresponding to the one or more reference signal measurements, the respective reference signal resource identifiers associated with at least one reference signal resource set of the plurality of reference signal resource sets.

17. The apparatus of claim 15, wherein the instructions to transmit the control signal are executable by the processor to cause the apparatus to:
transmit the control signal indicating a reference signal measurement of a sounding reference signal associated with a reference signal transmission occasion, the reference signal transmission occasion being a last reference signal transmission occasion before a set of time resources allocated for the control signal, wherein the one or more reference signal measurements includes the reference signal measurement.

18. The apparatus of claim 15, wherein the instructions to transmit the control signal are executable by the processor to cause the apparatus to:
transmit the control signal indicating a reference signal measurement of a sounding reference signal according to a time domain offset, the time domain offset indicating a time duration between transmission of the plurality of sounding reference signals and a set of time resources allocated for the control signal, wherein the one or more reference signal measurements includes the reference signal measurement, and wherein the plurality of sounding reference signals includes the sounding reference signal.

19. The apparatus of claim 15, wherein the instructions to transmit the control signal are executable by the processor to cause the apparatus to:
transmit the control signal indicating that the one or more reference signal measurements corresponds to two or more reference signal resource sets of the plurality of reference signal resource sets, the two or more reference signal resource sets being within a time window associated with a filtering scheme associated with the one or more reference signal measurements.

20. The apparatus of claim 15, wherein the instructions are further executable by the processor to cause the apparatus to:
transmit, to the UE, a second control signal indicating that measurements for at least one of the one or more reference signal resource sets is to be included in the control signal.

21. The apparatus of claim 15, wherein the instructions are further executable by the processor to cause the apparatus to:
receive, from the UE, a request for the network entity to include measurements for at least one of the one or more reference signal resource sets in the control signal.

22. The apparatus of claim 15, wherein the instructions to transmit the control signal are executable by the processor to cause the apparatus to:
transmit, in the control signal, a first set of bits indicating a first measurement of a first reference signal resource set of the plurality of reference signal resource sets, and a second set of bits indicating a differential measurement relative to the first measurement, wherein the differential measurement relative to the first measurement indicates a quantized differential between the first measurement and a second measurement, and wherein a quantity of the first set of bits is greater than a quantity of the second set of bits.

23. The apparatus of claim 15, wherein the instructions to transmit the control signal are executable by the processor to cause the apparatus to:
transmit, to the UE, a sounding reference signal resource indicator indicating the one or more reference signal resource sets according to an order that is based at least in part on the one or more reference signal measurements.

24. The apparatus of claim 15, wherein the instructions are further executable by the processor to cause the apparatus to:
communicate an indication of a measurement threshold with the UE, wherein the one or more reference signal measurements satisfy the measurement threshold.

25-30. (canceled)
